(19) United States
(12) Patent Application Publication
(10) Pub. No.: US 2018/0032479 A1
(43) Pub. Date: Feb. 1, 2018

(54) UNIFIED CONTENT PUBLISHING SYSTEM

(71) Applicant: VUCLIP (SINGAPORE) PTE. LTD., SINGAPORE (SG)

(72) Inventors: Jian Ding, Cupertino, CA (US); Tejas Sakhardande, Thane (IN); Desmond Frias, Mumbai (IN); Deepti Paranjape, Mumbai (IN)

(21) Appl. No.: 15/265,020

(22) Filed: Sep. 14, 2016

(30) Foreign Application Priority Data
Jul. 28, 2016 (IN) 201611025846

(51) Int. Cl. G06F 17/21; H04L 29/08; G06F 17/22; G06F 17/24; G06F 17/28

(52) U.S. Cl. CPC G06F 17/211; G06F 17/248; G06F 17/28; G06F 17/2247; G06F 17/2288; H04L 67/20; G06F 17/2235

(57) ABSTRACT

A unified content publishing system permits packaging and publishing of content items to multiple sites at once. Content items are grouped together using content groupings. A single content grouping may be assigned for publication through multiple sites. The content grouping may furthermore be assigned template data and layout data for generating a content package comprising information about the content items in the content grouping. To simplify publication, the template data and layout data may be used to publish the content grouping across all sites to which the content grouping has been assigned. Content packages may be manipulated across multiple sites simply by editing the content grouping, the assigned template data, and/or the assigned layout data. A construct referred to herein as a placeholder facilitates the above mappings. Subsites may be generated for different language profiles or other attributes, and placeholders may be pushed to all subsites having specified attributes.

### PRIORITY CLAIM

This application claims benefit under 35 U.S.C. §119 of India Application No. 201611025846, filed Jul. 28, 2016, the entire contents of which is hereby incorporated by reference as if fully set forth herein. The applicant(s) hereby rescind any disclaimer of claim scope in the parent application(s) or the prosecution history thereof and advise the USPTO that the claims in this application may be broader than any claim in the parent application(s).

### TECHNICAL FIELD

Embodiments relate generally to electronic content publishing, and, more specifically, to techniques for automatically publishing content items to multiple sites using a centralized publication tool.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Online content distributors publish a variety of media content items to consumers. Published content items may range from amateur, user-uploaded video clips to high-quality television shows and movies. A content distributor publishes a content item by making the content item available electronically to client computing devices through one or more access mechanisms known as channels or sites. Such sites may include different web sites, web applications, mobile or desktop applications, online streaming channels, and so forth. A site may be hosted by the content distributor itself, or by another entity, such as an Internet Service Provider or web portal. A site may freely publish a content item to all client devices, or impose various access restrictions on the content item, such as requiring that the client device present credentials associated with a valid subscription that permits access to the content item, or requiring that the client device be accessing the site through a certain provider or within a certain geographic area.

A content distributor may distribute media content items produced by other entities, referred to herein as content providers. A content distributor may publish content that the distributor has stored within its own system on behalf of the content provider. For instance, if the content item is a video, the content provider may send a video file to the content distributor, and the content distributor may store and optionally process the video file for various purposes. The content distributor may then publish the content item from this location through its own servers. Or, the content distributor may publish a content item by publishing a link through which a consumer retrieves the content item from a location at which the content item is hosted by the content provider or another suitable entity.

Generally, the publishing of the content item involves various steps such as sending electronic data in which the content item has been encoded to one or more client devices over a computer network, and/or sending one or more client devices a “link” that indicates a location from which such electronic data may be requested over a computer network. Moreover, publication may also require preliminary steps such as identifying where within the site a content item should be published and in what manner the publication should occur. For instance, a web site may include a number of different pages targeted to different audiences and purposes. Publication may require determining on which pages to publish the content item, as well as in which specific places and in which specific forms (e.g. links, menus, embedded videos, etc.) the content item should be published within the determined page(s).

A content distributor may publish content items utilizing a content publishing system. A content publishing system provides user interfaces by which site administrators may identify which content to publish, and the manner of publication. Due to varying restrictions, publication objectives, and so forth, different sites may have different proprietary content publishing systems, particularly when hosted by different entities, even if a single content distributor is responsible for publishing content to each of the different sites. Similarly, each of the different sites may be monitored by their own proprietary reporting system.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustrative view of various aspects of an example system in which the techniques described herein may be practiced;

FIG. 2 is an illustrative view of various aspects of an example content publishing system;

FIG. 3 illustrates an example flow for specifying and assigning content packages to multiple sites or subsites;

FIG. 4 illustrates an example flow for publishing content packages to a dynamically-generated site or subsite;

FIG. 5 illustrates an example user interface for defining and/or editing attributes of a site;

FIG. 6 illustrates an example user interface for adding and/or editing available subsites;

FIG. 7 illustrates an example user interface for adding and/or editing language profiles;

FIG. 8 illustrates an example user interface for adding and/or editing placeholders;

FIG. 9 illustrates an example user interface for editing a specific placeholder;

FIG. 10 illustrates an example user interface for continuing to edit the specific placeholder;

FIG. 11 illustrates an example user interface for editing placeholders at a site level; and

FIG. 12 is block diagram of a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described herein according to the following outline:
1.0. General Overview
2.0. Structural Overview
   2.1. Content Items
   2.2. Contexts
   2.3. Content Packages
   2.4. Publication Sites
   2.5. Subsites
   2.6. Content Curation Component
   2.7. Assignment Subsystem
   2.8. Placeholders
   2.9. Content Packager
   2.10. Rights Management Component
   2.11. Site-Level Customization
   2.12. Reporting subsystem
   2.13. User Access Subsystem
   2.14. Miscellaneous
3.0. Functional Overview
   3.1. Specifying Content Packages
   3.2. Publishing Content Packages
4.0. Example Interfaces
   4.1. Site Profile
   4.2. Subsite Definition
   4.3. Language Profile
   4.4. Placeholder Programming
   4.5. Site-Level Customization
5.0. Example Embodiments
6.0. Implementation Mechanism—Hardware Overview
7.0. Extensions and Alternatives

### 1.0. General Overview

Approaches, techniques, and mechanisms are disclosed for a unified content publishing system through which content items may be packaged and published to multiple sites at once, requiring less user interaction. According to one embodiment, content items are grouped together using content groupings, which are also referred to as contexts. A single content grouping may be assigned for publication through multiple sites. The content grouping may furthermore be assigned template data and layout data for generating a content package comprising information about the content items in the content grouping. A content package may include links to content items, excerpts or previews of content items, or even the content items themselves. To simplify publication, the template data and layout data may be used to publish the content grouping across all sites to which the content grouping has been assigned. Content packages may be manipulated across multiple sites simply by editing the content grouping, the assigned template data, and/or the assigned layout data.

In an embodiment, some or all of the above assignment processes are facilitated by use of a construct referred to herein as a placeholder. A user may generate a placeholder and associate the placeholder with a context identifier as well as one or more sites. The placeholder carries with it some or all of the template data and layout data. In an embodiment, different types of placeholders have different template data and/or layout data, such that simply by creating a placeholder of a certain type and associating that placeholder with a context identifier, a user is assigning the template data and layout data associated with that type to the placeholder.

In an embodiment, publication sites are subdivided into subsites, corresponding to different publication attributes such as language profiles or themes. For example, with a given site, there may be separate subsites for each of a plurality of different languages. Content groupings may be assigned to distinct subsites rather than sites. In an embodiment, a placeholder may be assigned to a specific publication attribute, such as a specific language profile. The content grouping associated with the placeholder is thus automatically published to all subsite(s) having that specific language profile or other publication attribute on the sites that have been assigned to the placeholder.

In an embodiment, template data and/or layout data for a content grouping that has been associated with several sites or subsites may be overridden at the individual site or subsite level. For instance, a placeholder that has been assigned to all sites having a certain language profile may be associated with override data that changes the way a content package is generated for the placeholder on just a specific one of those sites.

In other aspects, the invention encompasses computer apparatuses and computer-readable media configured to carry out the foregoing techniques.

### 2.0. Structural Overview

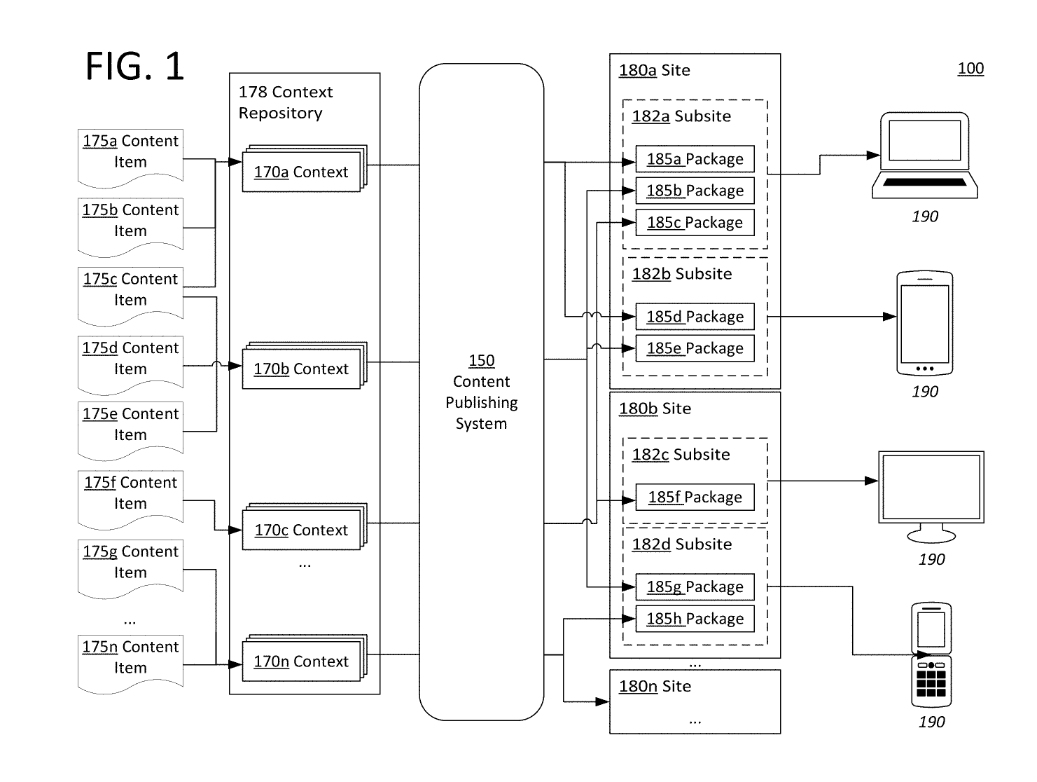

FIG. 1 is an illustrative view of various aspects of an example system 100 in which the techniques described herein may be practiced, according to an embodiment. System 100 comprises one or more computing devices. These one or more computing devices comprise any combination of hardware and software configured to implement the various logical components described herein, including components 150-190. For example, the one or more computing devices may include one or more memories storing instructions for implementing the various components described herein, one or more hardware processors configured to execute the instructions stored in the one or more memories, and various data repositories in the one or more memories for storing data structures utilized and manipulated by the various components.

2.1. Content Items

System 100 facilitates the publishing of content items 175 by a content distributor to client devices 190. Content items 175, collectively depicted as content items 175a-175n, are digital files or streams that encode distinct items of electronic media, such as digital movies, digital television shows, digital video clips, digital music, or any other suitable electronic media. Some or all of content items 175 may be stored in a repository (e.g. database or file system) of content controlled directly by the content distributor. Some or all of content items 175 may be stored in external systems. Such content items 175 may be, for example, files or streams that are retrievable via requests to web server(s), or to other types of server(s) that access those external systems, for uniform resource locators (URLs) or other suitable identifiers.

2.2. Contexts

In publishing content items 175, system 100 utilizes a construct referred to herein as a context, and thus system 100 comprises a context repository 178 of contexts 170a-170n (collectively contexts 170). As used herein, a context is a grouping of content items, such as a playlist, which may or may not have a predefined order. A context may be described by a data structure, or collection thereof, having a unique context identifier and containing references to one or more content items, which are said to be mapped to, be associated with, or belong to the context. For instance, content items 175a-175c are depicted, for illustrative purposes, as mapped to context 170a, while content items 175c-e are depicted as mapped to context 170b. Note that a single content item 175 may be mapped to multiple contexts 170.

Depending on an embodiment, there may or may not be any constraint upon the source of content items 175 in a given context 170. For example, in one embodiment, a context 170 may comprise content items 175 both from one or more external streaming sources and from the content distributor's content repository. In another embodiment, a given context 170 may only include content items 175 from a single source and/or a single content provider. In an embodiment, the content items 175 in a context 170 may change over time, in which case the content items 175 currently in a context 170 may be determined by accessing the context 170 by its unique identifier(s) within the context repository 178.

A context 170 may be created for a variety of reasons. For instance, a user may create the context 170 to describe a collection of content items about a particular person or subject. Or, the user may create the context 170 to describe a news feed of recent news reports. Or, the user may create the context 170 to describe a collection of content items 175 that the user likes or thinks a target group of users may like. Or, the user may create a context 170 to describe an organized presentation of content items 175 that mixes popular content items with promotional materials. The exact objective of a user in creating a context 170 is, of course, not necessarily relevant to the techniques described herein.

Data describing the available contexts 170 may be stored in a suitable repository 178 of contexts 170, such as a database or file system. Depending on the embodiment, the context repository 178 may or may not be part of the content publishing system 150. Moreover, in some embodiments, there may be multiple context repositories 178. For instance, the content distributor may publish content items 175 to multiple sites 180, some or all of which may be hosted by different entities (e.g. service providers, web portals, etc.). Some or all of the entities may have their own separate and distinct context repositories 178 to which the content distributor has access. Or, different content providers may have their own context repositories 178.

2.3. Content Packages

System 100 comprises a content publishing system 150 that is configured to, among other aspects, generate content packages 185 based on the contexts 170. The content publishing system 150 is a combination of one or more computer devices collectively functioning as a server-based computer system to perform the publishing techniques described herein.

A content package 185 is a presentation of the content items 175 that are mapped to a context 170. A content package 185 is represented by display instructions in a suitable format, such as Hyper-text Markup Language (HTML) elements, XML elements, JavaScript code snippets, and/or other suitable data structures or code. The presentation embodied by the content package 185 may function as a content listing of some or all of the content items 170 to which a given client 190 has access, and may range from a simple listing of titles and accompanying links to more sophisticated displays such as a newsfeed-style collection of content excerpts, or an automatically scrolling banner in which each content item 175 is playable.

For example, a content package 185 may be a video element within a web page that automatically plays each content item 175 in a context 170 in succession, potentially in an order prescribed by the context 170. Or, a content package 185 may be a bulleted list of links to each content item 175. Or, a content package 185 may be a series of thumbnails for the content items 175 in a context 170, with or without accompanying metadata and links. Of course, content items 175 may be presented in a variety of way, and the techniques described herein are not necessarily limited to any particular presentation techniques or formatting options within the content packages 185.

According to an embodiment, content packages 185 may conform to different specified types, such that one content package 185 of a certain type may have a same general appearance and arrangement as another content package 185 of the same type. For example, one type of content package 185 may be arranged for presentation as a banner within a web page or application, while another type may be arranged for presentation as a feature within the web page or application, while another type may be arranged for presentation within a category section or link section within the web page or application. To this end, the content publishing system 150 may map contexts 170 to different templates.

A template comprises specific instructions for generating a specific type of content package 185 based on any given context 170. For example, a template may comprise non-variable elements and variable elements. A content package 185 may be generated by copying the template, leaving the non-variable elements unchanged, but replacing the variable elements with data indicated by the context 170. These non-variable elements are typically formatting elements, such as specific HTML tags or JavaScript presentation instructions, while the variable elements are typically metadata for the context 170 or content items 175, such as titles, genres, descriptions, URLs, and so forth.

Certain segments of the template may be copied for each content item 175 within the context 170, or a selected subset thereof (e.g. content items 175 to which a client 190 has rights, a highest priority number of items 175, as indicated by order within the context 170 and/or a relevancy engine, etc.). For example, the template may include instructions that designate a certain portion of the template, comprising a non-variable link tag, a title variable, and a source variable, as being repeatable for each content item 175. When processed to generate a content package 185 showing ten content items 175 from a corresponding context 170, the certain portion will be copied ten times. Each copy will have the same non-variable link tag, but different title and source metadata, replacing the title variable and the source variable.

Of course, the above example is just one example of a template comprising instructions for generating a content package 185. There are a number of templating mechanisms that provide similar results, and the described techniques are not limited to any specific type of templating mechanism. Note that any number of content packages 185 may be generated for a single context 170, and these content packages 185 may or may not be associated with the same template, and thus may or may not have similar appearances.

2.4. Publication Sites

The content publishing system 150 is further configured to publish the content packages 185 to a plurality of sites 180a-180n, collectively sites 180. A site 180 may be for example, one or more web sites, web portals, applications, or other electronic publication mechanisms. A site 180 is more generally an electronic publishing interface provided by one or more server computing devices, such as web servers or application servers, by which client computing devices 190 may request and receive information over one or more networks, such as the Internet. Client computing devices 190 may be, for example, desktop computers, laptop computers, tablet devices, smartphones or other mobile devices, set top devices, gaming consoles, and so forth, which execute web browsers and/or other applications to request information from sites 180 and display that information locally on monitors or other output devices.

Sites 180 may be hosted by any number of server systems operated by any number of entities. For example, in one embodiment, each site 180 is hosted by a same server system, but is separately addressable, such that the server system may determine from which site 180 a client 190 is requesting information based upon identifying information in the request (e.g. the domain name to which a request is directed, information in the URL path being requested, query string information, etc.). In another embodiment, at least some of the sites 180 may be hosted by different server systems. For example, the content distributor may operate multiple server systems on behalf of different entities, and each server system may host one or more sites 180. Or, the content distributor's system may publish content packages to sites 180 that are operated by different entities.

Sites 180 may communicate information in the form of, for example, web pages, JSON data structures, XML data structures, API responses, and so forth. The information typically includes presentation instructions, such as HTML, JavaScript, and/or other suitable instructions, that indicate how the information is to be arranged and displayed as a presentation at a client 190. The presentation instructions may include instructions to request and play content items 175 directly within sections of the presentations (i.e. sections corresponding to the content packages 185 that contain the various content items 175), and/or the presentation instructions may instruct the client device 190 to display links or other interface controls that, when selected by user input, cause the client device 190 to separately request and play the content items 175 outside of the presentation.

Client devices 190 may or may not access content items 175 through sites 180 directly. For example, the content distributor's system may include a separate server for sending or streaming certain video content, and the presentation instructions may direct clients 190 to request content items 175 from this separate server rather than from sites 180. As another example, if a content item 175 is hosted by an external source, the presentation instructions may instruct a client device 190 to stream the content item 175 from the external source rather than a site 180.

Content publishing system 150 may be configured to publish content packages 185 to sites 180 using any of a variety of techniques, depending on the embodiment. For instance, if a site 180 comprises a plurality of web pages stored as static, flat files, content publishing system 150 may publish a content package 185 by inserting the content package 185 within a corresponding web page file and saving the updated file. If the site 180 is hosted externally, the content publishing system 150 may instead publish the content package by sending the content package 185 along with appropriate insertion instructions to the web server at which the site 180 is hosted, and the web server may then perform the necessary insertion steps. The content package 185 may be periodically updated (e.g. to reflect changes to the appropriate context 170), and republished within the appropriate web page using the same technique.

As another example, if the site 180 comprises web pages that are generated dynamically, content publishing system 150 may initiate publication of a content package 185 by updating configuration data, database entries, or other suitable data in such a manner so as to ensure that an appropriate dynamically generated web page will include the content package 185 when generated. Similarly, if the site 180 is an application configured to present information provided by an application server, content publishing system 150 may initiate publication of a content package 185 by updating configuration data, database entries, or other suitable data in such a manner so as to ensure that the application server's responses include information for the content package 185.

In embodiments where a content package 185 is embedded within a dynamically generated web page or other presentation, the content publishing system 150 may or may not generate the content package 185 dynamically, based on the appropriate context 170. For instance, a web server or application server responsible for generating a web page or other presentation in which the content package 185 is to be published may send a request to the content publishing system 150 to return the content package 185 each time the web page or presentation is requested by a client 190. In some embodiments, however, the content package 185 may be generated periodically by the content publishing system 150 and cached (either by the content publishing system 150 or the web/application server), so as to reduce processing requirements.

In an embodiment, the content publishing system 150 includes the web server or application server system that hosts a site 180. Hence, steps for generating a content package 185 may be integrated directly into the steps for generating a web page or other presentation of information for the site 180.

2.5. Subsites

According to an embodiment, each site 180 may comprise one or more subsites 182. Each subsite 182 presents a different view of content items 175 available through the corresponding site 180, filtered and/or arranged differently for different purposes. A site 180 may have different subsites 182 for different languages or regions. For instance, a site 180 may comprise an English language subsite 182a, a Chinese language subsite 182b, and an Indonesian language subsite 182c. A site 180 might also have different subsites 182 for different events, themes, interest groups, demographic groups, and so forth. For instance, a site 180 may comprise a Bollywood-themed subsite 182a, a Christmas themed subsite 182b, and a Teen-themed subsite 182c. Different subsites 182 may also exist for different subscription levels, or any combination of the foregoing. More generally, different subsites 182 may exist for each of a plurality of different publication attributes, or combination thereof, including language profiles, themes, events, and so forth.

In an embodiment, each subsite 182 is a separately addressable web page or section within a web site, or a separately navigable tab or screen within an application. In this aspect, a subsite 182 may be considered a different channel of content on the site 180. In an embodiment, upon accessing a site 180, a visitor to the site is automatically presented with content from a designated subsite 182 that is associated with the visiting client device 190. The subsite 182 to associate with the visiting client device 190 may be determined based on any of a variety of factors, such as user credentials presented by the client device 190, demographic or language preferences associated with the device 190 or the user credentials, a subscription level associated with the device 190 or the user credentials, a geographic region associated with the device 190 or the user credentials, the current date and time, and so forth. However, depending on the embodiment, a visitor may still be able to access content from other subsites 182 using various navigation menus and/or by browsing to the address of another subsite 182 directly.

2.6. Content Curation Component

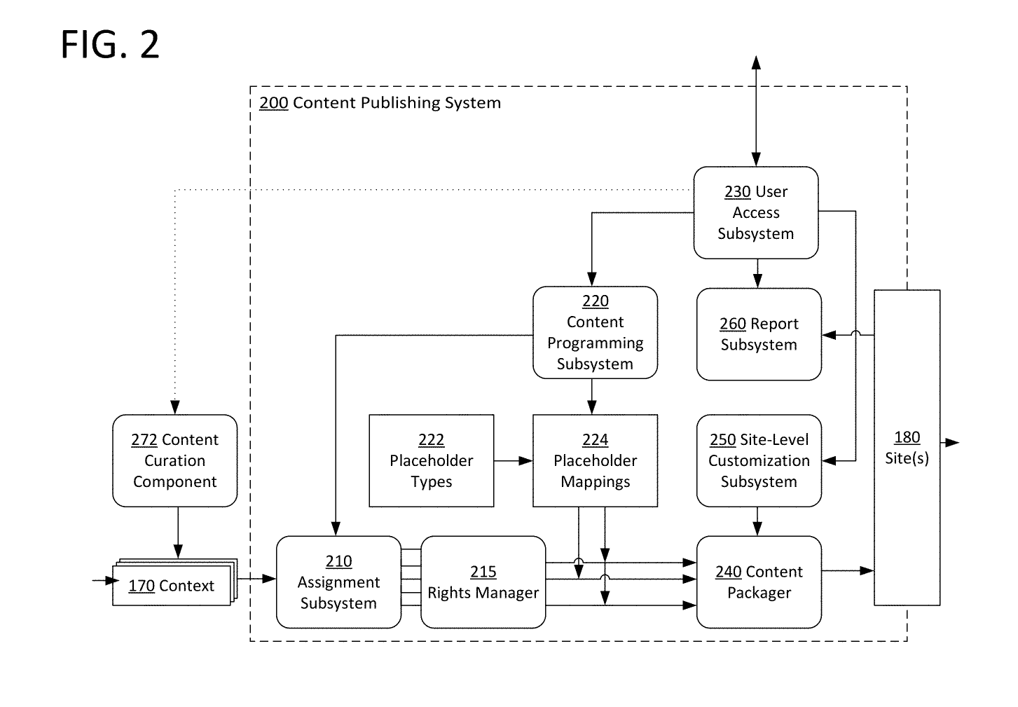

FIG. 2 is an illustrative view of various aspects of an example content publishing system 200, according to an embodiment. System 200 comprises one or more computing devices. These one or more computing devices comprise any combination of hardware and software configured to implement the various logical components described herein, including components 210-272. For example, the one or more computing devices may include one or more memories storing instructions for implementing the various components described herein, one or more hardware processors configured to execute the instructions stored in the one or more memories, and various data repositories in the one or more memories for storing data structures utilized and manipulated by the various components.

System 200 is an example of content publishing system 150 in FIG. 1. Other content publishing systems 150 may have fewer or additional elements in varying arrangements.

Content publishing system 200 may be utilized in conjunction with a content curation component 272, configured to generate and/or edit data describing contexts 170. According to an embodiment, a context 170 may be created in the course of human interaction with a context editing interface, or “tool,” provided by the content curation component 272. A human operator may access a user interface (e.g. a web-based interface, or a graphical user interface provided by a software application) in which the human operator may request to create a new context 170, or to access a named context 170 that was previously created and stored in a context repository 178. The human operator may assign or edit various characteristics of the context 170 such as a name, unique identifier(s), descriptions, attributes, or other metadata. The human operator may specify content items 175 to add and/or remove from the context 170 by specifying an external URL, internal identifier, or any other suitable reference for the content item 175. Of course, a variety of other types of interfaces are possible. For instance, an interface control may be provided in connection with a web page or web browser, by which a user may indicate that a video that the user is currently watching should be added to either a previously selected default context 170, or to a context 170 that the user then selects from a pull-down menu or other interface.

Content curation component 272 may also or instead add content items 175 to a context 170 programmatically. For example, a user may specify that a context 170 should be mapped to one or more content feeds. Content feeds may include frequently updated listings of contents that may be requested by or pushed directly to subscribers periodically and/or in response to being updated. The content feeds may be published in any suitable format, including without limitation RSS, XML, JSON, and so forth. Any content item 175 within a content feed associated with the context 170 may automatically be added to the context 170. Similarly, a user may specify that a context 170 should be mapped to the content distributor's content repository, an external content repository, or any other source, such that content items 175 from the source are automatically added to the context 170. If the source is a source to which content items 175 are regularly added, the context editing tool may automatically monitor the source for new content items 175, which, when detected, are automatically added to the context 170.

A context 170, and/or a source linked thereto, may also be associated with one or more filtering criteria, such that only content items 175 whose criteria match those of the context 170 are automatically added to the mapped context 170. For instance, metadata for the media content items 175 may, among other aspects, facilitate automatic context creation processes. As part of various content ingestion and/or curation processes, metadata may be collected for some or all of the content items 175 from various sources (e.g. from content providers and/or specialized metadata providers). Metadata may, for instance, be embedded within the content items 175, embedded within content feeds from which the content items 175 are obtained, or specified when the content items 175 are uploaded to the content distributor's system. Additional associated metadata for content items 175 may be generated or retrieved after receiving the content 175, whether to supplement or substitute existing metadata. Examples of such metadata may include, for instance, titles, actors, release years, genres, categories, tags, studios, directors, etc. A context 170 may include filtering criteria that indicates, for a given content feed, repository, or source, what metadata a content item 175 should have if the content item 175 is to be added to the context 170.

In response to context creation or editing input received via the user interface of a context editing tool, and/or in response to periodic monitoring of a source associated with a context 170, the content curation component 272 may generate appropriate data to describe the context 170 that was created and/or edited. This data may be stored in a suitable repository 178 of contexts 170. Depending on the embodiment, the content curation component 272, like the context repository 178, may or may not be part of the content publishing system 200. For instance, the content curation component 270 may be part of a content programming subsystem 220 within system 200, or provided entirely separately from system 200. In an embodiment, the content curation component 178 is provided and operated exclusively by the content distributor. However, in other embodiments, there may be multiple content curation components 272. For instance, the content distributor may publish content items 175 to multiple sites 180, some or all of which may be hosted by different entities (e.g. service providers, web portals, etc.). Some or all of the entities may have their own context editing tools by which they generate contexts 170 to add to the content distributor's context repository 178, or to separate and distinct context repositories 178 to which the content distributor has access. Or, in another embodiment, different content providers may have their own context editing tools by which they generate and submit contexts 170 to the content distributor's system.

In at least one embodiment, certain types of content feeds, web pages, or other data structures may be treated as contexts 170. Hence, a content provider need not explicitly access a context editing tool to create a context, but may instead provide a context 170 to the content publishing system 200 by providing the content publishing system with a URL for a feed, web page, or other suitable data structure. The content publishing system 200 may then parse the data structure to identify content items 175 belonging to the context 170.

2.7. Assignment Subsystem

Content publishing system 200 comprises an assignment subsystem 210 configured to determine which contexts 170 to publish on which sites 180 and/or subsites 182. To this end, content publishing system 200 may maintain assignment data that associates each context 170 with one or more sites 180 and/or subsites 182. Such assignment data may take a variety of forms. For instance, the assignment data for a given context 170 may be a straightforward record in which each site 180 or subsite 182 to which the context 170 is to be published is listed, or a collection of records associated with the context 170.

In an embodiment, the assignment data may take the form of one or more attributes associated with the context 170, which attributes may be compared to attributes of each site 180 and/or subsite 182 to determine where to publish a context 170. For example, a context 170 may be assigned an attribute that indicates that the context 170 pertains to content items 175 in a certain language, such as Vietnamese or Cambodian. Based on this language attribute, assignment data may automatically publish the context 170 to sites 180 or subsites 182 that are intended for audiences who speak that language. Similarly, a context 170 may be associated with attributes indicating categories or themes that are relevant to the context 170, and published to any subsites 182 that are similarly associated with such attributes. Such attributes may be found within the context 170 itself, or indicated separately to the assignment subsystem 210.

In an embodiment, the assignment data may feature combinations of attributes and specific mappings. For instance, the assignment data may indicate that a context 170 is to be published to all English or Thai language subsites 182 on a site 180a and 180c, but not on a site 180b. Or, the assignment data may include override data that, in addition to the attribute-based assignment mechanism, indicates a specific site 180 or subsite 182 on which to publish a context 170.

According to an embodiment, system 200 comprises a content programming subsystem 220 by which suitable assignment data is generated. Via a user interface of the content programming subsystem 220, a human operator may specify, for instance, a location and/or identifier of a context 170, along with assignment data for that context 170, such as specific sites 180 and/or subsites on which to publish the context 170, or attributes of sites/subsites on which the context 170 should be published. In other embodiments, assignment data may be generated for certain contexts 170 automatically, without human input.

2.8. Placeholders

According to an embodiment, contexts 170 may be associated with presentation information through the use of constructs referred to herein as placeholders. In an embodiment, a placeholder is a data structure that at least associates a context 170 with a template for generating one or more content packages 185 for that context 170. The placeholder may comprise the template directly, or be associated with the template. For instance, there may be different types 222 of placeholders that are associated with different types of templates.

In an embodiment, a placeholder further includes or is associated with layout information for the content package 185, indicating where, within a larger presentation of information such as a web page on a site 180 or subsite 182, to present the content package 185, relative to other content packages 185 or information within the larger presentation. For instance, a placeholder may include information indicating that the generated content package 185 should be placed within a header section, sidebar section, main section, or other section of a presentation. Again, there may be certain types 222 of placeholders that are associated with certain layout areas within the larger presentation. For instance, there may be a banner placeholder type 222 that not only includes a template for formatting a content package in an appropriate manner for a banner section of a subsite, but also indicates that the content package should in fact be placed in the banner section.

The placeholder may further include or be associated with ordering information indicating, for instance, that the generated content package should occupy a certain position within the designated section relative to other content (e.g. the last content package in the sidebar, the second content package in the main section, and so forth).

In an embodiment, the placeholder may further include auxiliary data such as a title, icon, or context caption, that should be inserted at a certain point within the generated content package. In embodiments where the context 170 itself includes such data, specification of the auxiliary data within the placeholder may override the data inside the context 170.

According to an embodiment, the content programming subsystem 220 includes an interface that allows a user to specify placeholders to use for specific contexts 170, either globally, or on specific sites 180 or subsites 182. Such information may be stored as placeholder mapping data 224. For instance, when specifying a site 180 or subsite 182 to assign to a context 170, a user may also specify a placeholder to utilize for the assignment. The placeholder will thus be utilized to generate the content package 185 that appears on the assigned site 180 or subsite 182. In an embodiment, a placeholder includes data indicating which context 170 the placeholder is associated with. The placeholder may be copied to or otherwise associated with other sites 180 and/or subsites 182, thus simplifying the publication of the context 170 to multiple sites 180 and/or subsites.

In an embodiment, a placeholder mapping 224 may further be utilized by the assignment subsystem 210 as a site and/or subsite assignment mechanism. For example, a placeholder may be linked both to a context 170 and to various subsite attribute(s), such as a language profile or subsite themes. Rather than requiring that the placeholder be copied to each individual subsite 182 on which the context 170 is to be published, the context 170 associated with the placeholder is automatically published on all subsites 182 that have the linked subsite attribute(s). In another embodiment, the placeholder is automatically made available to each subsite with the linked subsite attribute(s), but must still be enabled for the subsite 180 separately before being published. In an embodiment, the placeholder may further be associated with data indicating on which specific sites 180 the context 170 should be published, and thus content packages are only generated for the subsite(s) 182 on these sites 180 that have the indicated attribute(s).

In an embodiment, a context 170 may be assigned to a subsite 182 multiple times, with different placeholders, thus producing content packages 185 of different appearances within the same subsite 182, but presenting the same content items 175.

2.9. Content Packager

System 200 further comprises a content packager 240 that takes a context 170 as input, generates a context package 185 based on that context 170 and an associated template, and publishes that content package 185 within the relevant site 180 or subsite 182. For example, for each subsite 182 with which a context 170 is associated, the content packager 240 may generate a corresponding content package 185 in the subsite 182, thus causing content items 175 within the context 170 to become available on the subsite 182. The content packages 185 generated for a given context 170 may be the same for each subsite 182, or different subsites 182 may associate the context 170 with different presentation formats and arrangements. Likewise, the content package 185 may be in the same position on each subsite 182, or be associated with different positions on different subsites 182. In embodiments where placeholders are utilized, the content packager 240 utilizes the placeholder mapped to the context 170 to format and layout the content package 185 within the relevant site 180 and/or subsite 182.

2.10. Rights Management Component

According to an embodiment, system 200 may further comprise a rights management component 215. The rights manager 215 is configured to perform various filtering operations to ensure that only content for which a given client 190 has rights is published to that client 190. Depending on the embodiment, the rights manager 215 filters individual content items 175 and/or entire contexts 170 from publication. For instance, the rights manager 215 may be disposed between the assignment subsystem 210 and content packager 240, essentially blocking the content packager 240 from publishing contexts 170 that are assigned to a subsite 182 but to which a given client 190, or group of clients, that access the subsite 182 should not have access.

Or, the rights manager 215 may be integrated with the content packager 240, such that for each content item 175 in a context 170, prior to content packager 240 inserting information about the content item 175 into a content package 185, the content packager 240 checks with rights manager 215 to ensure that rights for the content item 175 are available to the requesting client 190, site 180, and/or subsite 182. If rights are not available for the content item 175, the content packager 240 does not include the content item 175 in the content package 185.

The rights manager 215 is configured to identify rights data associated with certain content items 170. The rights data for a content item 175 indicates attributes of sites 180, subsites 182, and/or clients 190 that are permitted to view or publish the content item 175. These attributes may include geographic regions or countries where the content item 175 may be played (or is not permitted), providers over whose networks the content item 175 is or is not permitted to be played, subscription levels required to view the content item, or any other suitable attribute upon which rights management decisions may be made. These attributes may reflect restrictions or permissions assigned to the content item for legal purposes, provider purposes, business rules, marketing decisions, and so forth. The restrictions or permissions described by the rights data may be associated with specific time frames, such that, for example, content items 175 that are not accessible in one region or at one subscription level at a certain time may become accessible subsequently. Rights data may also or instead be associated with groups of content items 175, such as contexts 170, all content items from a given source, all content items from a certain content provider, and so forth.

The rights manager 215 may be configured to determine whether rights to a content item 175 are available on any of a number of different levels, depending on the embodiment. In an embodiment, rights manager 215 may be configured to determine rights on a site-by-site basis, or subsite-by-subsite basis. Each site 180 and/or subsite 182 may be associated with certain attributes having rights implications, such as regions, subscription levels, portal or service provider identity, and so forth. The rights manager 215 may compare these attributes to the rights data for the content item 175, if any, to determine whether the site 180 and/or subsite 182 is entitled to publish the content item 175.

For instance, suppose a first context 170 includes a first content item 175, and is associated with both a first site 180 and a second site 180. If the first site 180 is a portal for a certain mobile carrier, and the rights data indicates that the certain mobile service provider does not yet have a license to publish the first content item 175, the rights manager 215 may block publication of a first content item 175 to the first site 180, whereas the rights manager 215 may allow publication of the content item 175 to a second site 180 associated with a mobile carrier that does have a license to publish the content item 175. Note that both the first site 180 and the second site 180 may still be permitted to publish other items 175 in the context 170, if the rights data indicates that the carriers have licenses to these content items 175.

As another example, suppose the rights data for a certain content item 175 indicates that the content distributor may currently distribute a certain content item exclusively to a certain geographic region. The rights manager 215 may thus block the content item 175 from being published to any subsite 182 that is not associated with the geographic region. As yet another example, certain content items 175 may be marked as premium content, requiring a subscription to view. The rights manager 215 may prevent sites 180 or subsites 182 that do not require a subscription (i.e. that a user does not have to login to) from publishing these premium content items 175.

In embodiments where sites 180 comprise dynamically generated presentations, rights manager 215 may also or instead operate on a client-by-client basis. The rights manager 215 identifies various attributes of the client 190 in response to whose request the content packager 240 is currently generating content packages 185, such as the current geographic location of the client 190, a service provider via which the client 190 is accessing the site 180, a device type of the client 190, a user account associated with the client 190, and so forth. Based on these attributes, the rights manager 215 determines, for each content item 175 that would otherwise be published to the client device 190, whether the rights data associated with the content item 175 permits the client device 190 to access the content item 175. If not, then the rights manager 215 blocks the content packager 240 from including the content item 175 in any packages 185 published to the client 190.

For example, information in the request header sent by the client 190 when requesting a subsite 182 may indicate that the client 190 is in a certain country or using a certain provider that is not currently licensed to view a certain content item 175. The rights manager 215 may thus block access to that content item 215 for the client 190. As another example, a context 170 may include certain premium content items 175. The rights manager 215 may block these premium content items 175 from publication if the client device 190 does not have a subscription to premium content items 175.

In an embodiment, the rights manager 215 may instead be deployed between clients 190 and servers that send the content items 175 to the clients 190. Information about the content items 170 may therefore be published to the clients 190, but when the clients 190 attempt to stream or other access the content items 175, the clients 190 may be redirected to a page or screen that explains that the clients 190 do not have access to the content items 175, and optionally explains how the clients may obtain rights to view the content items 175.

2.11. Site-Level Customization

In an embodiment, system 200 further comprises a site-level customization component 250. Site-level customization component 250 may generate site-level customization instructions that add to or override template instructions, layout instructions, or other aspects of a content package 185 generated for a specific site 180 or sub-site 182. When generating the content package 185 for a specific placeholder or context 170 assigned to a specific site 180 or subsite 182, the content packager 240 may be configured to look for site-level customization instructions for the pairing, and follow those instructions, if found.

For instance, a placeholder mapped to a certain context 170 may instruct the content package 240 generate a content package 185 that uses a certain font or style. This font or style may be acceptable for most sites 180 and/or subsites 182 on which the context 170 is published, but for a certain subsite, a different font or style is desired. Rather than create a completely different placeholder for the certain subsite 182, a user may utilize a site-level customization component to generate site-level customization instructions for the subsite 182 to utilize the different font or style in the content package for the context 170.

Site-level customization instructions may add or edit any aspect of a content package 185, including without limitation, editing the title or description of the content package 185, filtering the content items 175 described in the content package 185, adding or changing the content items 175, adjusting the template or position of the content package 185, and so forth.

2.12. Reporting Subsystem

In an embodiment, servers hosting various sites 180 record various information related to content item distribution in one or more reporting databases. For instance, the servers may record the identity of each content item 175 they publish and if or when each content item 175 was actually played. Information indicating how often and/or when other events occur may likewise be recorded, such as requests for specific content items 175, searches for specific content items 175, recommendations of certain content items 175, purchases of specific content items 175, and so forth. Information about client devices 190 involved in each event may be recorded, such as the type of client device 190, the location of the client device 190, a user identifier associated with the client device 190, demographic information associated with that user identifier, whether the client device 190 had a certain subscription, how long the client device 190 took to download a content item 175, the specific subsite 182 and/or content package 185 through which the content item 175 was accessed, how much of the content item 175 was actually consumed by the client device 190 (e.g. how much of a video the user actually watched), and so forth.

According to an embodiment, system 200 may include a reporting subsystem 260 configured to analyze and report information in the one or more reporting databases. Reporting subsystem 260 may comprise, for instance, a web site or application interface configured to communicate information with users of system 200 and/or users of external systems. The reported information may simply be information stored in the one or more reporting databases. Or, the reported information may be derived from the information stored in the one or more reporting databases.

For instance, the information may include graphs or charts illustrating metrics derived from information logged in a reporting database, such as of a total number of content items 175 published over a given period of time. Such information may further be subdivided by various attributes of the content items 175, sites 180 or subsites 182 through which the content items 175 were accessed, and/or client devices 190 to which the content items 175 are distributed. Reporting subsystem 260 may further report information via notification messages that are sent in response to defined events or triggers with respect to information in a reporting database.

2.13. User Access Subsystem

System 200 may, in an embodiment, further comprise a user access subsystem 230. The user access subsystem 230 is configured to restrict usage of administrative functionalities to certain users, and helps provide overall security to the system 200. For instance, certain users may only be provided access to only a limited number of components 272, 220, 260, or 250. As another example, users may only be provided with the ability to edit assignment data and/or placeholder data for specific sites 180 or subsites 182. As another example, users may only be provided with the ability to view report data for specific sites 180 or subsites 182. In an embodiment, a user's interactions with system 200 pass through the user access subsystem 230 to ensure compliance with the user access restrictions. In other embodiments, each component of system 200 may be configured to request verification from the user access subsystem 230 of a user's right to take an action before performing that action.

2.14. Miscellaneous

Systems 100 and 150 illustrate only one of many possible arrangements of components configured to provide the functionality described herein. Other arrangements may include fewer, additional, or different components, and the division of work between the components may vary depending on the arrangement. For example, in some embodiments, elements such as components 215, 220, 222, 230, 250, 260, and 272 may be omitted, along with any other components relied upon exclusively by the omitted component(s). Although certain numbers of elements are depicted in FIG. 1 and FIG. 2, it will be apparent that system 100 may be utilized to publish any number of content items 175 to any number of clients 190, using any number of contexts 170 to generate any number of packages 185, and that any number of such packages 185 may be published on any number of sites 180 having any number of subsites 182.

### 3.0. Functional Overview

In an embodiment, among other aspects, publication of content packages of content items from, potentially, multiple providers and sources, to multiple sites and audiences is greatly simplified using centralized content curation and programming techniques, such as described herein.

3.1. Specifying Content Packages

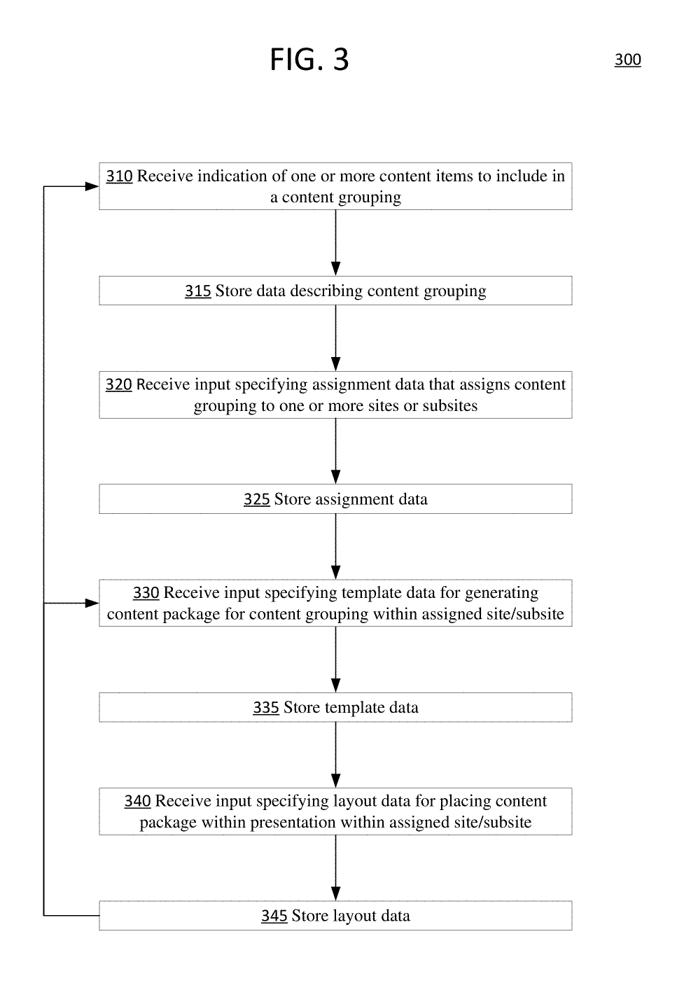

FIG. 3 illustrates an example flow 300 for specifying and assigning content packages to multiple sites or subsites, according to an embodiment. The various elements of flow 300 may be performed in a variety of systems, including systems such as systems 100 and 150, described above. In an embodiment, each of the processes described in connection with the functional blocks described below may be implemented using one or more computer programs, other software elements, and/or digital logic in any of a general-purpose computer or a special-purpose computer, while performing data retrieval, transformation, and storage operations that involve interacting with and transforming the physical state of memory of the computer.

Block 310 comprises receiving an indication of one or more content items to include in a content grouping, such as a context 170. Such an indication may be provided, for example, by input into a content curation component, such as content curation component 272. The input may include user input, input via an API, input via a content feed or other listing from which the items are imported, and/or any other suitable input that specifies one or more references to the content items to include in the content grouping. The reference for a single content item may be, for example, by an internal or external URL, or other suitable identifier. One or more sets of content items may be referenced by URLs that correspond to data structures in which multiple content items are listed, such as MRSS feeds, file system directories, folders, database queries, and so forth. The indication of one or more content items may optionally include filtering input that selects among the content items listed in such sets based upon various criteria such as title, genre, description, and so forth.

Block 315 comprises storing data describing the content grouping, including the indication of the one or more content items, in a suitable location, such as context repository 178. The data may further include various specified metadata, such as a content grouping identifier, category, description, curator identifier, and so forth.

Block 320 comprises receiving input specifying assignment data that assigns the content grouping to one or more sites or subsites, such as sites 180 and subsites 182, for publication. This input may take a variety of forms. For instance, a content programming interface, such as may be provided by content programming subsystem 220, may allow a user to specify a content grouping identifier along with specific sites or subsites at which the content grouping should be published. As another example, a content programming interface may allow a user to specify a content grouping identifier and a language profile or other attribute to associate with the content grouping. In so doing, the user is specifying that the content grouping is assigned to all sites or subsites that match the specified language profile or attribute. As another example, in addition to a specified language profile or attribute, a user may select specific sites to publish the content grouping to. The content grouping is thus assigned only to subsites, within the specific sites, that match the specified language profile or attribute.

Block 325 comprises storing this assignment data. Any suitable database or other data structure may be utilized to store the assignment data. In an embodiment, the assignment data may be stored in conjunction with placeholders, as described in other sections. Hence, storing the assignment data may simply involve storing a data structure describing the assigned placeholder for the content grouping and assigned sites/subsites.

Block 330 comprises receiving input specifying template data for generating a content package for the content grouping within an assigned site or subsite, such as described in other sections. Block 330 may comprise actually inputting the template data directly, and/or the template data may be specified, partially or fully, by selecting predefined templates. For instance, block 330 may comprise selecting a placeholder of a certain type and optionally inputting additional auxiliary template data.

Block 335 comprises storing the specified template data, in any suitable form. If the specified template data is in fact a predefined template, block 335 may simply comprise storing data indicating which predefined template has been selected. For instance, if the template data was specified by virtue of a banner-type placeholder having been selected, block 335 comprises storing data indicating that a banner-type placeholder has been selected for the content grouping.

Block 340 comprises receiving input specifying layout data for placing the content package within a presentation within an assigned site or subsite. This layout data will typically indicate a specified section within the presentation to show the content package. Since a presentation may be subdivided into sections in many ways, the exact sections that may be selected will vary from implementation to implementation. In an embodiment, the layout data may take other forms, such as indications of screen coordinates. In an embodiment, the layout data may also indicate a specific priority level for the content package within its specified sections, so as to determine which content package to show, or which content package to show first, if multiple packages are assigned to a same section. In an embodiment, the layout data may be at least partially dictated by the type of placeholder assigned to the content grouping.

Block 345 comprises storing the layout data, again in any suitable form. For instance, if the layout data was specified by virtue of a certain type of placeholder having been selected, block 345 comprises storing data indicating that the certain type of placeholder has been selected for the content grouping, along with the priority level for the placeholder.

Blocks 330-345 may be repeated a number of times for each assigned site or subsite. However, in some embodiments, template data and layout data may be assigned to multiple sites and/or subsites at the same time, reducing the amount of effort required to design content packages for these sites and/or subsites.

For instance, a placeholder may be created, and then associated with all sites or subsites to which the content grouping is assigned. If customization is needed for a particular site or subsite, site-level customizations to the template and/or layout data may be specified accordingly. In some embodiments, a content grouping may be assigned to multiple placeholders, which may be propagated to different sets of sites or subsites to generate different content packages on these sites or subsites based on the same content grouping. In an embodiment, a single subsite may have multiple content packages for a single content grouping.

Blocks 310-345 may further be repeated for any number of content groupings and assignments for any number of sites or subsites. FIG. 3 illustrates but one example of a method for specifying content packages to publish to sites or subsites. Other methods may include fewer or additional elements in varying arrangements. For example, in an embodiment, additional inputs may be received specifying various auxiliary data to associate with a content package, such as titles, descriptions, metadata, or formatting options to apply in addition to the assigned template and layout data. In other embodiments, the template data and/or the layout data may be optional.

3.2. Publishing Content Packages

Once content packages have been specified, and the relevant information describing those content packages (e.g. assignment data, placeholders, etc) has been stored, the content items within those content packages are ready to be published. Generally, the publishing of the content item involves various steps, including sending a “link” to the content item to one or more clients. A link may, for example, take such forms as a uniform resource locator (“URL”), uniform resource identifier (“URI”), or other address or identifying information that references a location from which the content item may be requested, such as from a content distributor server or a third-party server. The link may be published by embedding the link within a web page, such as in the source of a hyperlink element on which a user may click to request the content item, or the source of a video element that is automatically played when the web page is loaded. The link may alternatively be published by including the link in information returned to various client applications that interface with the content publishing system, such as in a JSON stream returned by the server in response to an API call from the client to fetch a list of available content items.

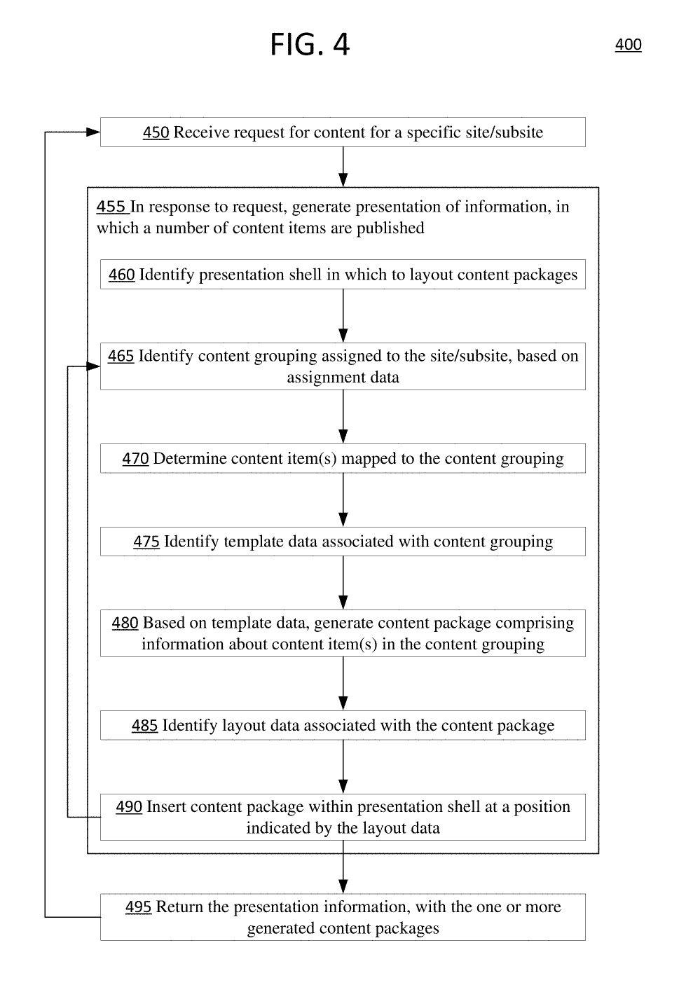

FIG. 4 illustrates an example flow 400 for publishing content packages to a dynamically-generated site or subsite, according to an embodiment. As with flow 300, the various elements of flow 400 may be performed in a variety of systems, including systems such as systems 100 and 150, described above. In an embodiment, each of the processes described in connection with the functional blocks described below may be implemented using one or more computer programs, other software elements, and/or digital logic in any of a general-purpose computer or a special-purpose computer, while performing data retrieval, transformation, and storage operations that involve interacting with and transforming the physical state of memory of the computer.

Block 450 comprises receiving a request for content for a specific site or subsite. For instance, a client such as a client 190 may send an HTTP request over a network for a web page from a subsite 182 hosted by a web application server. Or, a client application may send an API request for content packages to show within certain areas of an application interface.

Block 455 comprises, in response to the request, generating a presentation of information, such as a web page or application screen, in which a number of content items are published. Block 455 is subdivided into blocks 460-490.

Block 460 comprises identifying the presentation shell or template in which to layout content packages. For instance, if the presentation will take the form of a web page, block 460 may comprise generating the containing web page structure, with designated sections into which content packages may be placed. More generally, block 460 comprises generating some containing presentation structure into which content packages may be inserted.

Block 465 comprises identifying a content grouping assigned to the site or subsite, based on assignment data, including the assignment data stored in block 325. For instance, an assignment subsystem, such as assignment subsystem 215, may query a database of assignment data to locate the identifier of each content grouping assigned to the site or subsite requested in block 450. Each identified content grouping may be processed, in turn. In an embodiment, block 465 may comprise identifying placeholders that are active for or otherwise associated with the site, and then determining, for each placeholder, what content grouping is identified.

Block 470 comprises determining one or more content items that are mapped to the content grouping. These content items may have originally been indicated in performance of step such as described in block 310. In some embodiments, the determining may simply involve looking up all content items mapped to the content grouping in a data repository, such as one or more context repositories 180. In other embodiments, the determining may further involve accessing content feeds and/or other listings that have been mapped to the content grouping to identify content items that are currently in the listings. Note that the one or more content items mapped to the content grouping may have changed since the content grouping was initially specified, as a result of intermediate edits to the content grouping or to an underlying feed or content listing referenced by the content grouping.

In an embodiment, the identified one or more content items need not necessarily include all content items that are mapped to the content grouping. For example, on account of space limitations, only a certain number of content items may be published in the content package for the content grouping. Block 470 may thus involve sorting the content items by some ranking mechanism (e.g. popularity, recency, etc.) and selecting only a top certain number of content items in said sorting.

Block 475 comprises identifying template data associated with the content grouping, such as template data stored in block 335. For example, block 475 may comprise identifying a placeholder associated with the content grouping and the requested site or subsite. The template data may be found in, or otherwise associated with, the placeholder.

Block 480 comprises, based on the template data, generating a content package comprising information about some or all of the one or more content items in the content grouping. The content package may be generated as described in other sections herein (e.g. by a content packager 240).

Block 485 comprises identifying layout data associated with the content package, such as layout data stored in block 345. For example, block 485 may comprise identifying a placeholder associated with the content grouping and the requested site or subsite. The layout data may be found in, or otherwise associated with, the placeholder.

Block 490 comprises inserting the content package within the presentation shell identified in block 460, at a position indicated by the layout data. For instance, the layout data may indicate to place the content package in a banner section, sidebar section, category section, or other specified location. If another content package has already been inserted in the specified section, the new content package may be placed above, below, or beside the other content package, depending on the embodiment and/or the layout data.

Blocks 465-490 are then repeated for each content grouping identified within the assignment data as being associated with the site or subsite.

Block 495 comprises returning the presentation information, with the one or more content packages generated via blocks 465-490, to the client, which is configured to display a presentation to a user based on the returned information. For instance, if the presentation is a web page, block 495 may comprise returning HTML and/or JavaScript instructions to the client's browser, which, when interpreted, are rendered as a web page to display at the client. In returning the presentation information, information about the content items identified in block 470 is published to the client. The client may then access (i.e. request) the content items based on the published information.

Flow 400 is but one example of a method by which content items within a content package may be published. Others methods may include fewer or additional steps in varying in orders. For example, in an embodiment, flow 400 may further involve a step of filtering the content items and/or the identified contexts based on rights data, such as described with respect to rights manager 215. As another example, flow 400 may involve a step of applying a site-level customization to a content package. Note that blocks 450-495 may be performed any number of times, for any number of clients and any number of sites or subsites.

While flow 400 deals with dynamically generated presentations, such as dynamically generate web pages, variations upon flow 400 may be utilized to generate static presentations. For instance, instead of block 450 being a request for content from a site, block 450 may be a determination that it is time to generate or update a static presentation, such as a static web page, either because some periodic interval has lapsed, or because some other triggering condition has been met. Block 495 then comprises storing the generated or updated static presentation.

According to some embodiments, variations upon flow 400 may further subdivide performance of the described steps amongst two or more entities. For example, a third-party server system or client may perform steps 460 and 490, but request that the content distributor's server system perform some are all of steps 465-485, and return the relevant output.

### 4.0. Example Interfaces

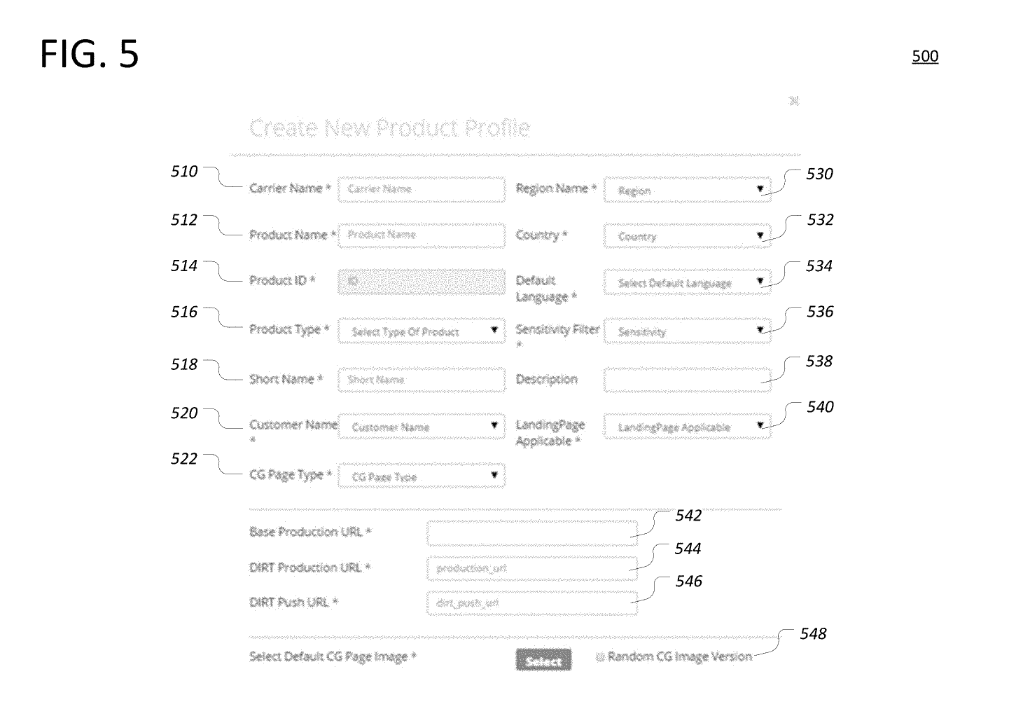

FIGS. 5-10 illustrate example user interfaces for defining and/or editing various data utilized in a content publishing system, such as system 200, according to an embodiment. The example interfaces may be generated by, for example, a web server or application server in communication with a client browser or application over a network. The interfaces provide various interface controls, referred to as fields, through which users submit input that specifies various attributes to the content publishing system. In an embodiment, some or all of interfaces may be provided by a content programming subsystem, such as content programming subsystem 220. Of course, in other embodiments there are a wide variety of other interfaces that may be utilized for editing the same data structures, and it will further be recognized that the various data attributes collected by the example interfaces are but examples of attributes that may be utilized in practicing the described techniques. In other embodiments, many of the attributes may be optional, eliminated, and/or replaced by different attributes.

4.1. Site Profile

FIG. 5 illustrates an example user interface 500 for defining and/or editing attributes of a site, such as a site 180, according to an embodiment. Interface 500 comprises fields 510-548.

In interface 500, as in certain other example interfaces, a site is referred to as a “product.” Field 510 is a field through which the content publishing system may receive input that provides or edits the name of an entity associated with the site. For example, in an embodiment, each site may be associated with a different mobile service provider, or carrier, whose customers may access the defined site to obtain content. As another example, some or all of the sites may be associated with a web portal. In some embodiments, for sites hosted by the content publishing system, the content publishing system may only provide the site to client devices accessing the content publishing system through the entity named in field 510 (e.g. via the entity's network, or having first visited or logged into the entity's web portal). In an embodiment, the specified carrier may serve as an attribute that has implications on whether a rights management subsystem will permit access to certain specific content items through the site.

Fields 512, 514, and 518 are fields through which the content publishing system may receive input that provides or edits names and other identifiers of the site. These names may be used for various purposes, such as in database records, in other internal interfaces that need to identify the site (e.g. when creating context assignment data), and/or for displaying as part of the title, header, or footer of web pages or other presentations of information generated for the site.

Field 516 is a field through which the content publishing system may receive input that provides or edits the type of the site. Various types of sites may be generated, having different appearances, settings, subscription schemes, available content items, and so forth.

Field 520 is a field through which the content publishing system may receive input that provides or edits the name of a customer for whom the site is being created. In some embodiments, the customer may be the same as the entity specified in field 510, while in others the customer may be different.

Field 522 is a field through which the content publishing system may receive input that provides or edits the type of a consent gateway through which clients, such as clients 190, must access the site. A consent gateway is a web page, application screen, popup dialog, or other interface that a client will be redirected to when attempting to access content from the site. The consent gateway typically requires some interaction from the client, such as input indicating that a user of the client has read various rules and restrictions, input indicating that a user of the client authorizes certain financial charges in exchange for being directed to the content, input indicating user credentials provided by the client for subscription verification purposes, input selecting what language to view the site in (if not the default language), and so forth.

Consent gateways may be shown every time content is accessed through the site, only the first time that content is accessed, only when the client attempts to access content to which the client does not have a valid license, prior to publishing any information about content, and/or at other times depending on the consent gateway type and the embodiment. In some embodiments, a user may select some or all of the aforementioned attributes of the consent gateway separately, while in others (such as depicted), some or all of the afore-mentioned attributes of the consent gateway are controlled by the type selected in field 522. In an embodiment, a user may also specify that no consent gateway is to be used.

Field 530 is a field through which the content publishing system may receive input that provides or edits the name of a region that is associated with the site. Multiple regions may be selected, in some embodiments. In an embodiment, the content publishing system may refuse to publish the site to clients unless the clients can be determined to be in the selected region(s). In an embodiment, the content publishing system may simply direct clients determined to be in the selected region(s) automatically to the site, when no specific site is requested. The selected region may also be utilized, in certain embodiments, by a rights management system, to control which content items are actually publishable to the site. In an embodiment, no region need be selected. The selected region(s) may furthermore control which specific languages of content are available through the site, and/or what default languages are available.

Field 532 is a field through which the content publishing system may receive input that provides or edits the name of a country that is associated with the site. The country may be used in similar manner to the region, to control access to the site, control which languages and/or default languages are available, and/or to determine rights to specific items of content through the site. Again, depending on the embodiment, multiple countries, or even no country, may be selected.

Field 532 is a field through which the content publishing system may receive input that provides or edits the default language for the site. By default, the site will be provided in this language to any requesting client, unless the client specifically selects a different language. If the site is to have multiple subsites, with different languages having their own subsites, then this option in effect controls what the default subsite is for the site. In an embodiment, each site has an assigned default language. In another embodiment, if no default language is provided, clients may be requested to select the language to use when entering the site.

Field 536 is a field through which the content publishing system may receive input that provides or edits the sensitivity level for the site.

Field 538 is a field through which the content publishing system may receive input that provides or edits the site description. This description may be utilized for various purposes, such as for displaying to internal users to help them quickly identify the nature of the site, or displaying on web pages or other presentations of information to client devices.

Field 540 is a field through which the content publishing system may receive input that provides or edits a landing page applicability setting.

Fields 542-546 are fields through which the content publishing system may receive input that provides or edits URL paths for the site. The paths correspond to locations from which clients may request content from the site.

Field 548 is a field through which the content publishing system may receive input that provides or edits an image to place on the consent gateway, if applicable. In an embodiment, a random image may be selected.

Upon receiving inputs that set some or all of these fields, a user may choose to save the site. Data describing the new or updated site is saved to a suitable repository, which is utilized by web or application server logic to generate presentations, such as web pages comprising content packages, to send to clients that request the site.

4.2. Subsite Definition

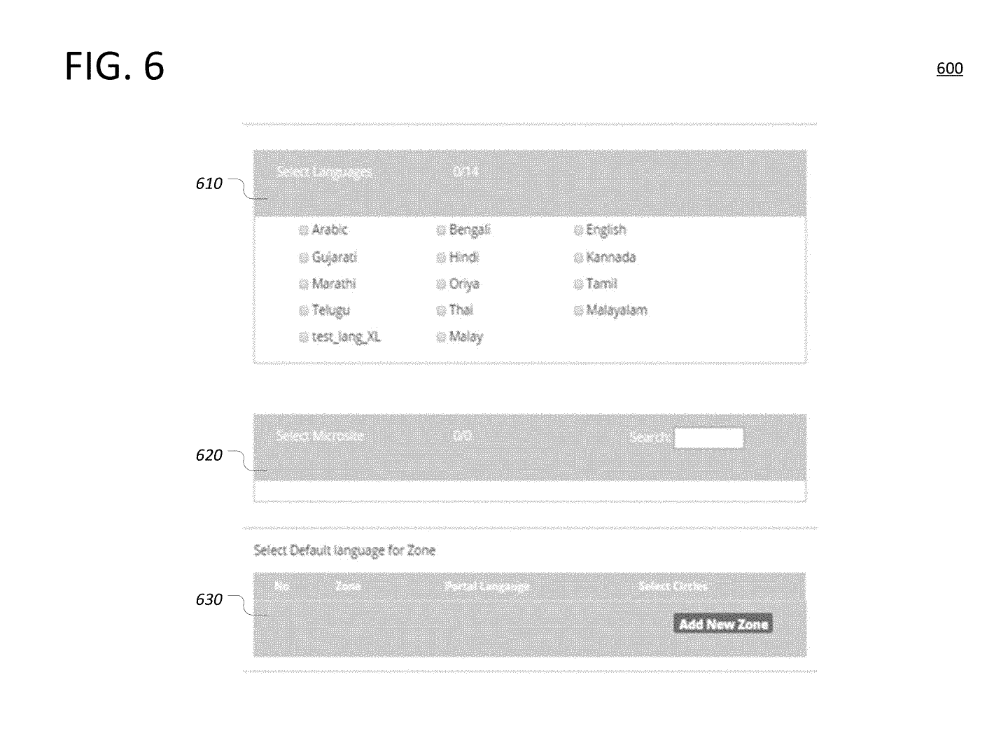

FIG. 6 illustrates an example user interface 600 for adding and/or editing available subsites, such as a subsite 182, according to an embodiment. Interface 600 comprises fields 610-630. Field 610 is a field through which the content publishing system may receive input that enables or disables subsites for various languages within a currently selected site. Field 610 comprises a list of named checkboxes, each corresponding to a different language profile. By selecting a language profile, a user instructs the content publishing system to enable a subsite corresponding to the language profile.

Field 620 is a field through which the content publishing system may receive input that enables or disables subsites (“microsites”) for different themes. For instance, a user may enable a subsite corresponding to a particular holiday or event.

Field 630 is a field through which the content publishing system may receive input that selects default languages for various zones within the currently selected site.

Upon receiving inputs that set some or all of these fields, a user may choose to save the data. Based on the saved data, the content publishing system generates various subsites for the currently selected site.

4.3. Language Profile

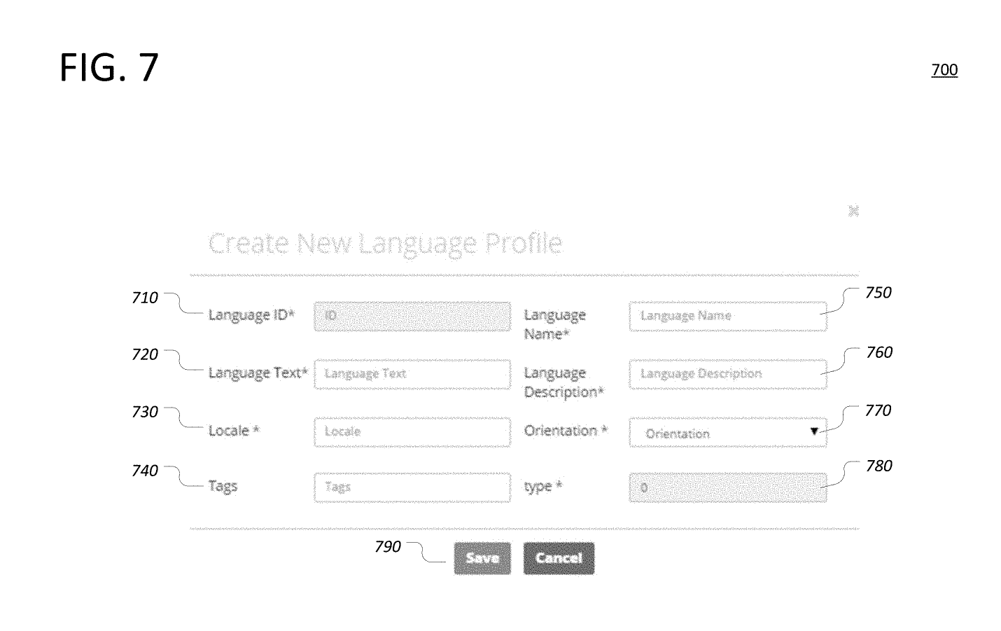

FIG. 7 illustrates an example user interface 700 for adding and/or editing language profiles, according to an embodiment. These language profiles may become available, for example, for selection within field 610 of FIG. 6. The defined attributes of the language profile may be inherited by and apply to any subsite generated for the language profile. Since a language profile may become available for selection on multiple sites, by defining a new language profile, a user may create subsites on multiple sites at once.

Interface 700 comprises fields 710-790. Fields 710, 720, and 750 are fields through which the content publishing system may receive input that provides or edits various names or identifiers for the language profile. These names or identifiers may be used to identify the language profile within database records, within internal programming interfaces, or within the published body of the corresponding subsites for the language profile.

Field 730 is a field through which the content publishing system may receive input that provides or edits a locale to associate with the language profile. Depending on the embodiment, multiple locales may be selected.

Field 740 is a field through which the content publishing system may receive input that provides or edits one or more tags to associate with the language profile.

Field 760 is a field through which the content publishing system may receive input that provides or edits a description of the language profile. This description may be utilized to quickly identify the purpose of the profile and/or to publish on the subsites associated with the language profile.

Field 770 is a field through which the content publishing system may receive input that provides or edits the orientation of the language profile (e.g. left-to-right or right-to-left).

Field 780 is a field through which the content publishing system may receive input that provides or edits a language profile type. The type of the language profile may impact additional, undepicted attributes associated with the language profile and its corresponding subsites.

Field 790 is a field through which the content publishing system may receive input that instructs the content publishing system to save the corresponding language profile. In response to receiving this input, the content publishing system may store data describing the language profile in a suitable data repository.

4.4. Placeholder Programming

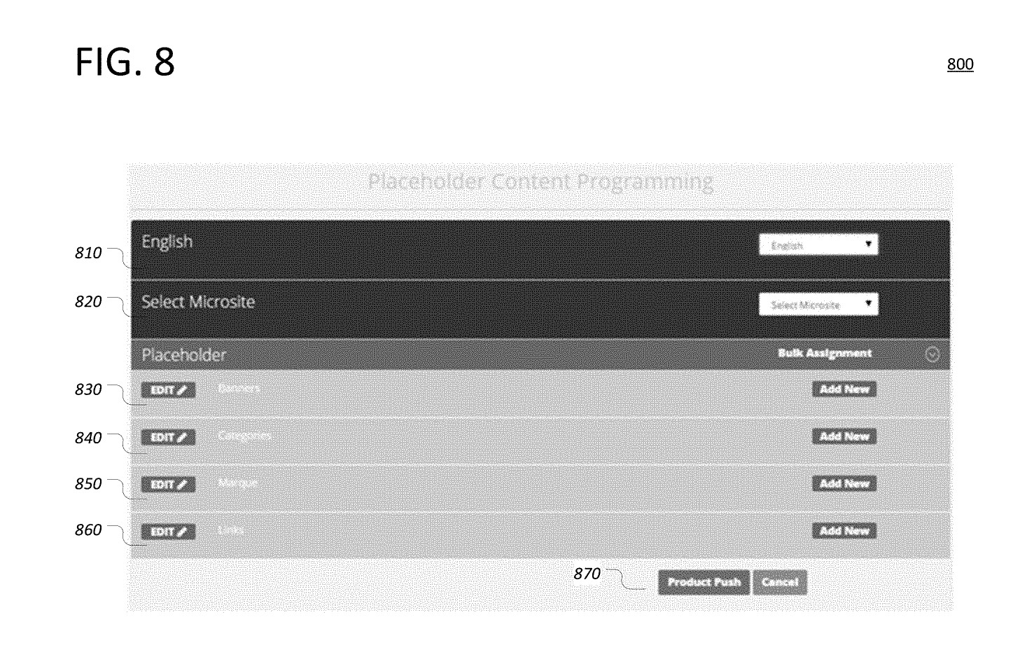

FIG. 8 illustrates an example user interface 800 for adding and/or editing placeholders, according to an embodiment. Interface 800 comprises fields 810-870. In the depicted interface, placeholders may be added or edited on a per-language-profile or per-microsite basis, meaning that the defined placeholders may be pushed to some or all subsites, across multiple sites, that are associated with the language profile or microsite.

Field 810 is a field through which the content publishing system may receive input that selects a current language profile (such as created in interface 700) for which to create placeholders. Field 820 is a field through which the content publishing system may receive input that selects a current microsite for which to create placeholders.

Field 830 is a field through which the content publishing system may receive input that adds and/or edits a banner-type placeholder for the currently selected language or microsite. Field 840 is a field through which the content publishing system may receive input that adds and/or edits a categories-type placeholder for the currently selected language or microsite. Field 850 is a field through which the content publishing system may receive input that adds and/or edits a marque-type placeholder for the currently selected language or microsite. Field 860 is a field through which the content publishing system may receive input that adds and/or edits a links-type placeholder for the currently selected language or microsite.

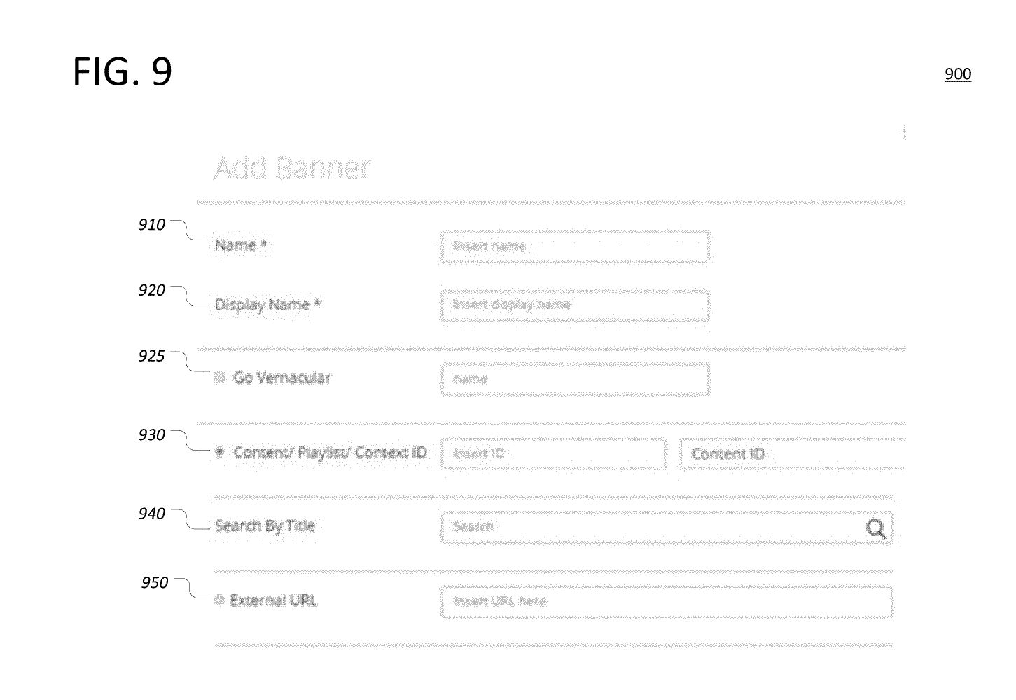

Adding or editing a placeholder will launch another dialog, such as depicted in FIG. 9, for defining attributes of the placeholder. As new placeholders of these types are created, they may be added to and listed within the interface 800. In other interfaces or embodiments, other types of placeholders may also or instead be available. When a user is ready to save these placeholders, the user may select to “push” the new placeholders to the relevant site, thereby publishing the associated contexts, by selecting control 870.

FIG. 9 illustrates an example user interface 900 for editing a specific placeholder, according to an embodiment. Interface 900 comprises fields 910-950. Though the depicted interface is for adding/editing a banner-type placeholder, similar interfaces may be provided for other types of placeholders.

Fields 910, 920, and 925 are fields through which the content publishing system may receive input that adds and/or edits names for the current placeholder. These names may be used for internal record-keeping, identifying the placeholder in internal interfaces, and/or for naming content packages generated from the placeholder.

Fields 930-950 are fields through which the content publishing system may receive input that adds and/or edits the context associated with the placeholder. In field 930, a user may specify a context by an internal identifier. In field 940, the user may search for a context by name. In field 950, the user may specify an external URL corresponding to the context.

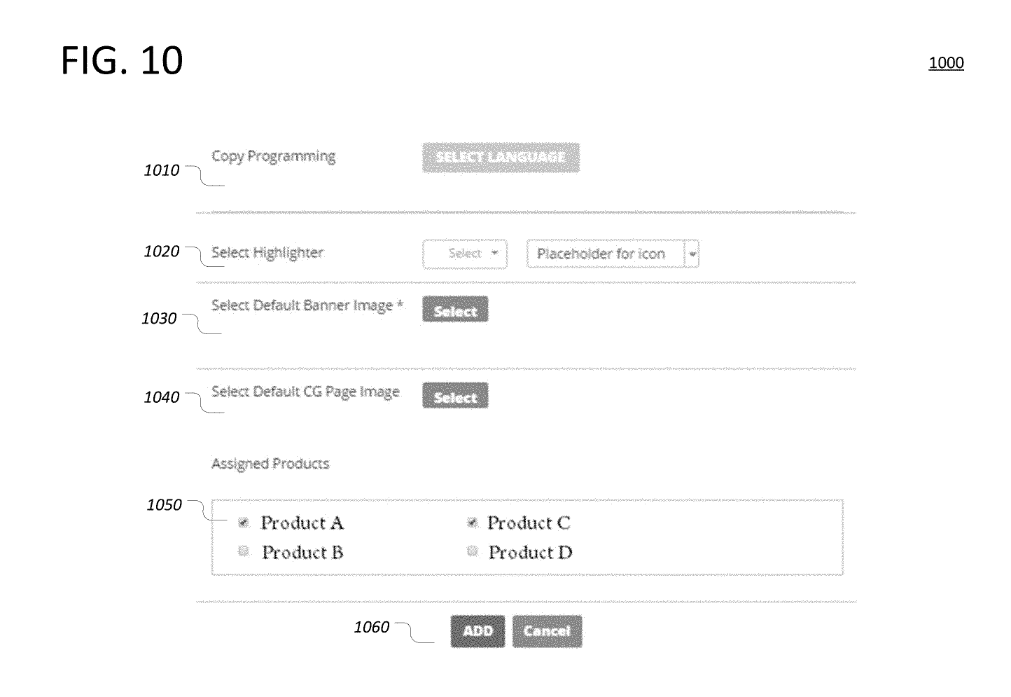

FIG. 10 illustrates an example user interface 1000 for continuing to edit the specific placeholder, according to an embodiment. Interface 1000 comprises fields 1010-1060.

Field 1010 is a field through which the content publishing system may receive input that selects to copy the current placeholder to other language profiles or microsites. Field 1020 is a field through which the content publishing system may receive input that selects a highlighter icon for the placeholder. Field 1020 is a field through which the content publishing system may receive input that selects a highlighter icon for the placeholder.

Field 1030 is a field through which the content publishing system may receive input that selects a banner image for the placeholder, that will appear on content packages generated for the placeholder. Field 1040 is a field through which the content publishing system may receive input that selects a default image to show on the content gateway for the placeholder.

Field 1050 is a field through which the content publishing system may receive input that selects on which specific sites the placeholder is enabled. Content packages will be generated for the placeholder on only those sites selected in field 1050, and only for the language profile or microsite for which the placeholder was created.

Field 1060 is a field through which the content publishing system may receive input that instructs the content publishing system to add or save the placeholder. When the content publishing system receives this instruction, the content publishing system saves a placeholder construct that indicates assignment data for the context selected in fields 930-950, assigning the context to the sites selected in fields 1050, and more particularly to those subsites of the sites selected in fields 1050 that correspond to the currently selected language profile or microsite. Moreover, the placeholder construct indicates, by its type, template data and layout data for a content package to generate for this context.

4.5. Site-Level Customization

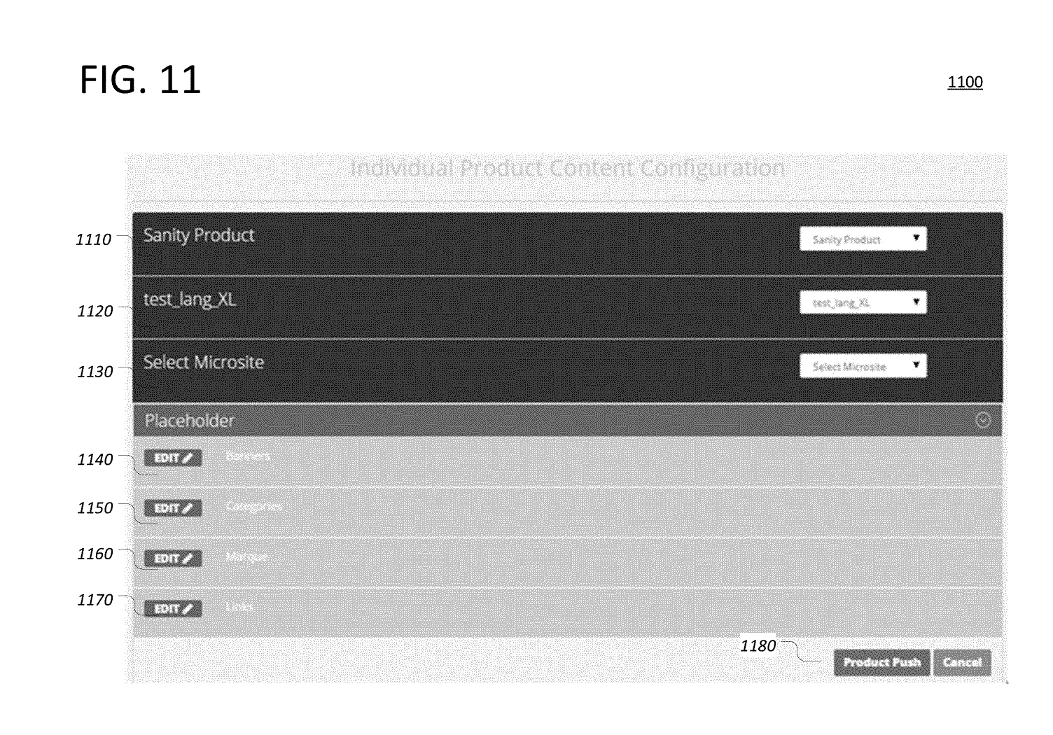

FIG. 11 illustrates an example user interface 1100 for editing placeholders at a site level, according to an embodiment. Interface 1100 is similar to interface 800, but allows a user to override various aspects of the placeholders that have been enabled for the site. For example, fields 1140-1170 function in the same manner as fields 830-860, but only with respect to the current site rather than an entire language profile.

Field 1110 is a field through which the content publishing system may receive input that selects a site for site-level customization. Fields 1120 and 1130 are fields through which the content publishing system may receive input that selects a subsite for site-level customization, either by language profile or by microsite. Field 1180 is a field through which the content publishing system may receive input that instructs the content publishing system to save site-level customizations.

### 5.0. Example Embodiments

Examples of some embodiments are represented, without limitation, in the following clauses:

According to an embodiment, a system comprises: a programming component configured to associate content groupings with publication placeholders, the content groupings comprising media content items selected from a plurality of media content items; an assignment component configured to identify subsites, within a plurality of sites, in which to publish the content groupings based on the publication placeholders associated with the content groupings; a packaging component configured to generate publishable content packages for the content groupings based on the publication placeholders associated with the content groupings; and a publishing component configured to publish the content packages for the content groupings to the subsites identified for the content groupings, the content packages providing access to the content items which their respective content groupings comprise.

In an embodiment, the system further comprises a content repository, comprising the plurality of content items.

In an embodiment, the system further comprises a context creation component, configured to generate content groupings comprising content items from the plurality of content items.

In an embodiment, the programming component is further configured to receive input associating the publication placeholders with different publication languages, wherein the assignment component is configured to identify the subsites in which to publish the content groupings based on the input associating the publication placeholders with different publication languages, the different publication languages corresponding to different subsites within the plurality of sites, at least one of the plurality sites having at least two subsites corresponding to the at least two different publication languages, respectively.

In an embodiment, the publication placeholders include at least template data and layout data, wherein a first content grouping, associated with a first placeholder, is published as a content package with the same template data and layout data on at least two different subsites across at least two different sites in the plurality of sites.

In an embodiment, the publication placeholders indicate how content items within assigned content groupings are to be displayed within corresponding content packages, as well as where within subsite pages or screens to display the content packages.

In an embodiment, a given content grouping may be associated with multiple publication placeholders, the packaging component consequently generating multiple content packages for the given content grouping having different appearance.

In an embodiment, a given content grouping is associated with multiple publication placeholders, the packaging component consequently generating multiple content packages for the given content grouping having different appearances on different subsites.

In an embodiment, the system further comprises a rights management component configured to filter particular content items from particular content packages on particular subsites based on comparing rights data associated with the particular content items to rights-indicating attributes associated with the particular subsites, a particular content item within a particular content grouping appearing in a first package for the particular content grouping on a first subsite, but not in a second package for the particular content grouping on a second subsite.

In an embodiment, the system further comprises a site-level customization component configured to customize the generated content packages for selected sites or subsites.

In an embodiment, the content groupings are video playlists.

In an embodiment, the publication placeholders include at least a banner placeholder corresponding to a banner layout for content items in an associated content grouping, and a link placeholder corresponding to a link list layout for content items in an associated content grouping.

In an embodiment, the system further comprises a reporting component configured to generate reports of content items served across multiple sites of the plurality of sites.

In an embodiment, the content items include one or more of: an external video stream from outside of the system, an internal video stream from within the system, or a downloadable file.

In an embodiment, the system further comprises one or more streaming servers configured to stream the content items to client devices.

In an embodiment, the publishing component comprises one or more web servers, the one or more web servers configured to publish the subsites in the form of web pages returned to client devices.

In an embodiment, the publishing component comprises one or more application servers, the one or more application servers configured to publish the subsites in the form of application screen information returned to associated applications executing on client devices.

In an embodiment, the publishing component is configured to publish the plurality of sites to different groups of client devices, wherein the publishing component is configured to select which subsite within a given site to publish to which client devices in a given group of client devices based at least partially upon associations between subsites and language profiles.

According to an embodiment, a method comprises: receiving programming inputs assigning content groupings to publication subsites within a plurality of publication sites, the programming inputs further assigning the content groupings to template data and layout data, the content groupings comprising different sets of media content items, a single content grouping assigned to multiple subsites using the same template data and layout data; identifying a particular subsite of the publication subsites for which to generate a presentation of information; identifying particular content groupings assigned to the particular subsite based on the assignment data; and, for each content grouping of the particular content groupings: determining content items mapped to the content grouping; identifying template data and layout data associated with the content grouping; based on the template data, generating a content package comprising information about the content items mapped to the content grouping, formatted in a manner specified by the template data; and inserting the generated content package into the presentation of information at a position indicated by the layout data.

In an embodiment, the programming inputs comprise placeholder input that defines placeholder constructs, including at least a first placeholder construct that assigns a first content grouping to multiple sites within the plurality of publication sites, and that further assigns the first content grouping to subsites, within the multiple sites, that have a certain publication attribute.

In an embodiment, the certain publication attribute is a language profile.

In an embodiment, the certain publication attribute is an associated theme or event.

In an embodiment, the first placeholder construct further assigns first template data and first layout data to the first content grouping, the first content grouping consequently being published using the same first template data and first layout data on subsites across the multiple sites.

In an embodiment, the method further comprises: receiving, from a client device, over a network, a request for the presentation of information; identifying the particular subsite based on the request; generating the presentation of information in response to the request; responding to the request by sending the presentation of information to the client device.

In an embodiment, the presentation of information is a web page.

In an embodiment, the method further comprises: for at least a first content grouping of the particular content groupings, for at least of first content item of a plurality of content items mapped to the first content grouping, comparing rights data for the first content item to rights-indicating attributes of the particular subsite or of a particular site to which the particular subsite belongs; based on the comparing determining whether to include the first content item in the presentation of information.

In an embodiment, the method further comprises: determining not to include the first content item in the particular site based on the comparing; and determining to include the first content item in a second site based on comparing the rights data to rights-indicating attributes of the second site.

In an embodiment, the rights-indicating attributes include one or more of a region associated with the particular site or the particular subsite, a country associated with the particular site or the particular subsite, a subscription-level associated with the particular site or the particular subsite, or a carrier or service provider associated with the particular site.

In an embodiment, the method further comprises: for at least a first content grouping of the particular content groupings, for at least of first content item of a plurality of content items mapped to the first content grouping, comparing rights data for the first content item to rights-indicating attributes of a particular client device or group of client devices; based on the comparing determining whether to include the first content item in the presentation of information.

In an embodiment, the media content items include one or more of: an external video stream, an internal video stream, or a downloadable file.

Other examples of these and other embodiments are found throughout this disclosure.

### 6.0. Implementation Mechanism—Hardware Overview

According to one embodiment, the techniques described herein are implemented by one or more special-purpose computing devices. The special-purpose computing devices may be desktop computer systems, portable computer systems, handheld devices, smartphones, media devices, gaming consoles, networking devices, or any other device that incorporates hard-wired and/or program logic to implement the techniques. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques.

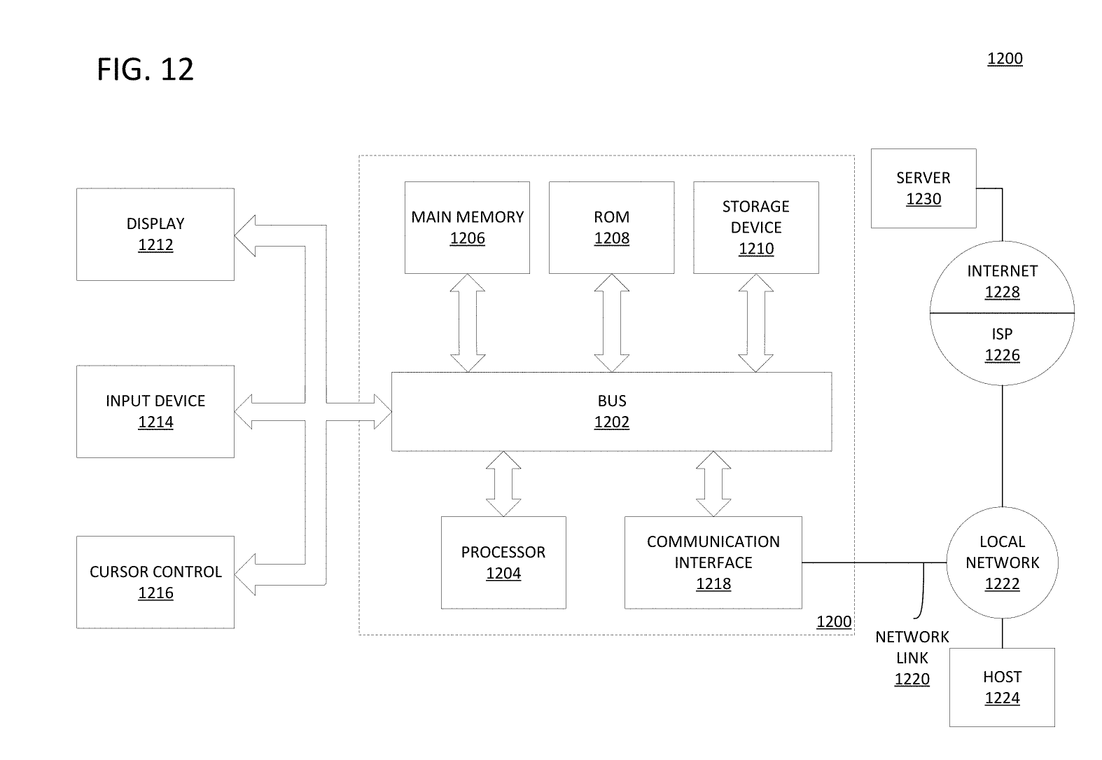

FIG. 12 is a block diagram that illustrates a computer system 1200 utilized in implementing the above-described techniques, according to an embodiment. Computer system 1200 may be, for example, a desktop computing device, laptop computing device, tablet, smartphone, server appliance, computing mainframe, multimedia device, handheld device, networking apparatus, or any other suitable device.

Computer system 1200 includes one or more busses 1202 or other communication mechanism for communicating information, and one or more hardware processors 1204 coupled with busses 1202 for processing information. Hardware processors 1204 may be, for example, a general purpose microprocessor. Busses 1202 may include various internal and/or external components, including, without limitation, internal processor or memory busses, a Serial ATA bus, a PCI Express bus, a Universal Serial Bus, a HyperTransport bus, an Infiniband bus, and/or any other suitable wired or wireless communication channel.

Computer system 1200 also includes a main memory 1206, such as a random access memory (RAM) or other dynamic or volatile storage device, coupled to bus 1202 for storing information and instructions to be executed by processor 1204. Main memory 1206 also may be used for storing temporary variables or other intermediate information during execution of instructions to be executed by processor 1204. Such instructions, when stored in non-transitory storage media accessible to processor 1204, render computer system 1200 into a special-purpose machine that is customized to perform the operations specified in the instructions.

Computer system 1200 further includes one or more read only memories (ROM) 1208 or other static storage devices coupled to bus 1202 for storing static information and instructions for processor 1204. One or more storage devices 1210, such as a solid-state drive (SSD), magnetic disk, optical disk, or other suitable non-volatile storage device, is provided and coupled to bus 1202 for storing information and instructions.

Computer system 1200 may be coupled via bus 1202 to one or more displays 1212 for presenting information to a computer user. For instance, computer system 1200 may be connected via an High-Definition Multimedia Interface (HDMI) cable or other suitable cabling to a Liquid Crystal Display (LCD) monitor, and/or via a wireless connection such as peer-to-peer Wi-Fi Direct connection to a Light-Emitting Diode (LED) television. Other examples of suitable types of displays 1212 may include, without limitation, plasma display devices, projectors, cathode ray tube (CRT) monitors, electronic paper, virtual reality headsets, braille terminal, and/or any other suitable device for outputting information to a computer user. In an embodiment, any suitable type of output device, such as, for instance, an audio speaker or printer, may be utilized instead of a display 1212.

In an embodiment, output to display 1112 may be accelerated by one or more graphics processing unit (GPUs) in computer system 1100. A GPU may be, for example, a highly parallelized, multi-core floating point processing unit highly optimized to perform computing operations related to the display of graphics data, 3D data, and/or multimedia. In addition to computing image and/or video data directly for output to display 1112, a GPU may also be used to render imagery or other video data off-screen, and read that data back into a program for off-screen image processing with very high performance. Various other computing tasks may be off-loaded from the processor 1104 to the GPU.

One or more input devices 1214 are coupled to bus 1202 for communicating information and command selections to processor 1204. One example of an input device 1214 is a keyboard, including alphanumeric and other keys. Another type of user input device 1214 is cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane. Yet other examples of suitable input devices 1214 include a touch-screen panel affixed to a display 1212, cameras, microphones, accelerometers, motion detectors, and/or other sensors. In an embodiment, a network-based input device 1214 may be utilized. In such an embodiment, user input and/or other information or commands may be relayed via routers and/or switches on a Local Area Network (LAN) or other suitable shared network, or via a peer-to-peer network, from the input device 1214 to a network link 1220 on the computer system 1200.

A computer system 1200 may implement techniques described herein using customized hard-wired logic, one or more ASICs or FPGAs, firmware and/or program logic which in combination with the computer system causes or programs computer system 1200 to be a special-purpose machine. According to one embodiment, the techniques herein are performed by computer system 1200 in response to processor 1204 executing one or more sequences of one or more instructions contained in main memory 1206. Such instructions may be read into main memory 1206 from another storage medium, such as storage device 1210. Execution of the sequences of instructions contained in main memory 1206 causes processor 1204 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1210. Volatile media includes dynamic memory, such as main memory 1206. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1202. Transmission media can also take the form of acoustic or light waves, such as those generated during radio-wave and infra-red data communications.

Various forms of media may be involved in carrying one or more sequences of one or more instructions to processor 1204 for execution. For example, the instructions may initially be carried on a magnetic disk or solid state drive of a remote computer. The remote computer can load the instructions into its dynamic memory and use a modem to send the instructions over a network, such as a cable network or cellular network, as modulated signals. A modem local to computer system 1200 can receive the data on the network and demodulate the signal to decode the transmitted instructions. Appropriate circuitry can then place the data on bus 1202. Bus 1202 carries the data to main memory 1206, from which processor 1204 retrieves and executes the instructions. The instructions received by main memory 1206 may optionally be stored on storage device 1210 either before or after execution by processor 1204.

A computer system 1200 may also include, in an embodiment, one or more communication interfaces 1218 coupled to bus 1202. A communication interface 1218 provides a data communication coupling, typically two-way, to a network link 1220 that is connected to a local network 1222. For example, a communication interface 1218 may be an integrated services digital network (ISDN) card, cable modem, satellite modem, or a modem to provide a data communication connection to a corresponding type of telephone line. As another example, the one or more communication interfaces 1218 may include a local area network (LAN) card to provide a data communication connection to a compatible LAN. As yet another example, the one or more communication interfaces 1218 may include a wireless network interface controller, such as a 802.11-based controller, Bluetooth controller, Long Term Evolution (LTE) modem, and/or other types of wireless interfaces. In any such implementation, communication interface 1218 sends and receives electrical, electromagnetic, or optical signals that carry digital data streams representing various types of information.

Network link 1220 typically provides data communication through one or more networks to other data devices. For example, network link 1220 may provide a connection through local network 1222 to a host computer 1224 or to data equipment operated by a Service Provider 1226. Service Provider 1226, which may for example be an Internet Service Provider (ISP), in turn provides data communication services through a wide area network, such as the world wide packet data communication network now commonly referred to as the “Internet” 1228. Local network 1222 and Internet 1228 both use electrical, electromagnetic or optical signals that carry digital data streams. The signals through the various networks and the signals on network link 1220 and through communication interface 1218, which carry the digital data to and from computer system 1200, are example forms of transmission media.

In an embodiment, computer system 1200 can send messages and receive data, including program code and/or other types of instructions, through the network(s), network link 1220, and communication interface 1218. In the Internet example, a server 1230 might transmit a requested code for an application program through Internet 1228, ISP 1226, local network 1222 and communication interface 1218. The received code may be executed by processor 1204 as it is received, and/or stored in storage device 1210, or other non-volatile storage for later execution. As another example, information received via a network link 1220 may be interpreted and/or processed by a software component of the computer system 1200, such as a web browser, application, or server, which in turn issues instructions based thereon to a processor 1204, possibly via an operating system and/or other intermediate layers of software components.

In an embodiment, some or all of the systems described herein may be or comprise server computer systems, including one or more computer systems 1200 that collectively implement various components of the system as a set of server-side processes. The server computer systems may include web server, application server, database server, and/or other conventional server components that certain above-described components utilize to provide the described functionality. The server computer systems may receive network-based communications comprising input data from any of a variety of sources, including without limitation user-operated client computing devices such as desktop computers, tablets, or smartphones, remote sensing devices, and/or other server computer systems.

In an embodiment, certain server components may be implemented in full or in part using “cloud”-based components that are coupled to the systems by one or more networks, such as the Internet. The cloud-based components may expose interfaces by which they provide processing, storage, software, and/or other resources to other components of the systems. In an embodiment, the cloud-based components may be implemented by third-party entities, on behalf of another entity for whom the components are deployed. In other embodiments, however, the described systems may be implemented entirely by computer systems owned and operated by a single entity.

In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

### 7.0. Extensions and Alternatives

As used herein, the terms “first,” “second,” “certain,” and “particular” are used as naming conventions to distinguish queries, plans, representations, steps, objects, devices, or other items from each other, so that these items may be referenced after they have been introduced. Unless otherwise specified herein, the use of these terms does not imply an ordering, timing, or any other characteristic of the referenced items.

In the drawings, the various components are depicted as being communicatively coupled to various other components by arrows. These arrows illustrate only certain examples of information flows between the components. Neither the direction of the arrows nor the lack of arrow lines between certain components should be interpreted as indicating the existence or absence of communication between the certain components themselves. Indeed, each component may feature a suitable communication interface by which the component may become communicatively coupled to other components as needed to accomplish any of the functions described herein.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. In this regard, although specific claim dependencies are set out in the claims of this application, it is to be noted that the features of the dependent claims of this application may be combined as appropriate with the features of other dependent claims and with the features of the independent claims of this application, and not merely according to the specific dependencies recited in the set of claims. Moreover, although separate embodiments are discussed herein, any combination of embodiments and/or partial embodiments discussed herein may be combined to form further embodiments.

Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A system comprising:
a programming component configured to associate content groupings with publication placeholders, the content groupings comprising media content items selected from a plurality of media content items;
an assignment component configured to identify subsites, within a plurality of sites, in which to publish the content groupings based on the publication placeholders associated with the content groupings;
a packaging component configured to generate publishable content packages for the content groupings based on the publication placeholders associated with the content groupings;
a publishing component configured to publish the content packages for the content groupings to the subsites identified for the content groupings, the content packages providing access to the content items which their respective content groupings comprise.

2. The system of claim 1, further comprising a context creation component, configured to generate content groupings comprising content items from the plurality of content items.

3. The system of claim 1, wherein the programming component is further configured to receive input associating the publication placeholders with different publication languages, wherein the assignment component is configured to identify the subsites in which to publish the content groupings based on the input associating the publication placeholders with different publication languages, the different publication languages corresponding to different subsites within the plurality of sites, at least one of the plurality sites having at least two subsites corresponding to the at least two different publication languages, respectively.

4. The system of claim 1, wherein the publication placeholders include at least template data and layout data, wherein a first content grouping, associated with a first placeholder, is published as a content package with the same template data and layout data on at least two different subsites across at least two different sites in the plurality of sites.

5. The system of claim 1, further comprising a rights management component configured to filter particular content items from particular content packages on particular subsites based on comparing rights data associated with the particular content items to rights-indicating attributes associated with the particular subsites, a particular content item within a particular content grouping appearing in a first package for the particular content grouping on a first subsite, but not in a second package for the particular content grouping on a second subsite.

6. The system of claim 1, wherein the content groupings are video playlists.

7. The system of claim 1, wherein the publishing component is configured to publish the plurality of sites to different groups of client devices, wherein the publishing component is configured to select which subsite within a given site to publish to which client devices in a given group of client devices based at least partially upon associations between subsites and language profiles.

8. A method comprising:
receiving programming inputs assigning content groupings to publication subsites within a plurality of publication sites, the programming inputs further assigning the content groupings to template data and layout data, the content groupings comprising different sets of media content items, a single content grouping assigned to multiple subsites using the same template data and layout data;
identifying a particular subsite of the publication subsites for which to generate a presentation of information;
identifying particular content groupings assigned to the particular subsite based on the assignment data;
for each content grouping of the particular content groupings:
determining content items mapped to the content grouping;
identifying template data and layout data associated with the content grouping;
based on the template data, generating a content package comprising information about the content items mapped to the content grouping, formatted in a manner specified by the template data;
inserting the generated content package into the presentation of information at a position indicated by the layout data.

9. The method of claim 8, wherein the programming inputs comprise placeholder input that defines placeholder constructs, including at least a first placeholder construct that assigns a first content grouping to multiple sites within the plurality of publication sites, and that further assigns the first content grouping to subsites, within the multiple sites, that have a certain publication attribute.

10. The method of claim 9, wherein the certain publication attribute is a language profile.

11. The method of claim 9, wherein the first placeholder construct further assigns first template data and first layout data to the first content grouping, the first content grouping consequently being published using the same first template data and first layout data on subsites across the multiple sites.

12. The method of claim 8, further comprising:
receiving, from a client device, over a network, a request for the presentation of information;
identifying the particular subsite based on the request;
generating the presentation of information in response to the request;
responding to the request by sending the presentation of information to the client device.

13. The method of claim 8, further comprising:
for at least a first content grouping of the particular content groupings, for at least of first content item of a plurality of content items mapped to the first content grouping, comparing rights data for the first content item to rights-indicating attributes of the particular subsite or of a particular site to which the particular subsite belongs;
based on the comparing determining whether to include the first content item in the presentation of information.

14. The method of claim 8, further comprising:
for at least a first content grouping of the particular content groupings, for at least of first content item of a plurality of content items mapped to the first content grouping, comparing rights data for the first content item to rights-indicating attributes of a particular client device or group of client devices;
based on the comparing determining whether to include the first content item in the presentation of information.

15. One or more non-transitory computer-readable media storing instructions that, when executed by one or more computing devices, cause:
receiving programming inputs assigning content groupings to publication subsites within a plurality of publication sites, the programming inputs further assigning the content groupings to template data and layout data, the content groupings comprising different sets of media content items, a single content grouping assigned to multiple subsites using the same template data and layout data;
identifying a particular subsite of the publication subsites for which to generate a presentation of information;
identifying particular content groupings assigned to the particular subsite based on the assignment data;
for each content grouping of the particular content groupings:
determining content items mapped to the content grouping;
identifying template data and layout data associated with the content grouping;
based on the template data, generating a content package comprising information about the content items mapped to the content grouping, formatted in a manner specified by the template data;
inserting the generated content package into the presentation of information at a position indicated by the layout data.

16. The one or more non-transitory computer-readable media of claim 15, wherein the programming inputs comprise placeholder input that defines placeholder constructs, including at least a first placeholder construct that assigns a first content grouping to multiple sites within the plurality of publication sites, and that further assigns the first content grouping to subsites, within the multiple sites, that have a certain publication attribute.

17. The one or more non-transitory computer-readable media of claim 16, wherein the certain publication attribute is a language profile.

18. The one or more non-transitory computer-readable media of claim 16, wherein the first placeholder construct further assigns first template data and first layout data to the first content grouping, the first content grouping consequently being published using the same first template data and first layout data on subsites across the multiple sites.

19. The one or more non-transitory computer-readable media of claim 15, wherein the instructions, when executed by one or more computing devices, further cause:
receiving, from a client device, over a network, a request for the presentation of information;
identifying the particular subsite based on the request;
generating the presentation of information in response to the request;
responding to the request by sending the presentation of information to the client device.

20. The one or more non-transitory computer-readable media of claim 15, wherein the instructions, when executed by one or more computing devices, further cause:
for at least a first content grouping of the particular content groupings, for at least of first content item of a plurality of content items mapped to the first content grouping, comparing rights data for the first content item to rights-indicating attributes of the particular subsite or of a particular site to which the particular subsite belongs;
based on the comparing determining whether to include the first content item in the presentation of information.
